(19) United States
(12) Patent Application Publication
(10) Pub. No.: US 2002/0177914 A1
(43) Pub. Date: Nov. 28, 2002

(54) Audio distribution and production system

(76) Inventor: Tim Chase, Holmdel, NJ (US)

Correspondence Address: MCANDREWS, HELD & MALLOY, LTD., 34TH FLOOR, 500 W. MADISON STREET, CHICAGO, IL, 60661, US

(21) Appl. No.: 10/083,902

(22) Filed: Feb. 26, 2002

Related U.S. Application Data
(63) Continuation of application No. 08/705,797, filed on Aug. 30, 1996.
(60) Provisional application No. 60/003,164, filed on Sep. 1, 1995.

(51) Int. Cl. G06F 17/00

(52) U.S. Cl. 700/94

(57) ABSTRACT

A data file delivery system is provided having, at a head end, a production subsystem which communicates with a delivery subsystem via a local area network, ISDN connection, and the like. The delivery subsystem communicates with an affiliate subsystem, at a tail end, via a satellite link, ISDN link and the like. The production subsystem enables a producer to create audio events which represent sequences of audio which are played to completion before another audio event occurs. Audio events are stored as audio files. Each audio event may include one or more of an audio sequence, text information, delivery instructions, and an attribute list having contact closure information and the like. Optionally, multiple audio events may be assembled at the production subsystem to form a play list. The audio files are transferred to the delivery subsystem. The delivery subsystem places the audio files in delivery envelopes and transmits the envelopes to the affiliate terminals. In addition, the delivery subsystem may transmit live audio and related contact closure information to the affiliate terminals. The affiliate terminal may be located at a user site. The affiliate terminals may store these events on the hard drive, play the events in real time or pass events to other affiliate terminals. The affiliate terminal may later play stored audio events.

### REFERENCE MATERIALS AND SOFTWARE INCORPORATED BY REFERENCE

The present application claims priority from provisional patent application Serial No. 60/003,164, filed Sep. 1, 1995, the entire content of which is expressly incorporated herein by reference including all software appendices and attached papers filed with the '164 provisional application.

The software utilized to implement the preferred embodiment of the present invention is attached in Appendices A-E on 5-3½″ diskettes labeled in the following manner. The software utilized to implement the affiliate controller of the preferred embodiment of the present invention is attached as Software Appendix A entitled “DAX Source.” The software utilized by the affiliate controller to interface with the digital audio cards is filed herewith in Software Appendix B entitled “Driver Source” and Software Appendix C entitled “DAC DSP Source.” The functions of the digital audio card are described in the papers attached to the '164 provisional application entitled “DAC Driver Design,” “DAX Audio Server Design,” “Design Notes,” and “Requirements.” The software that provides cooperation between the remote control terminal and the affiliate controller is filed herewith in Software Appendix D, entitled “Jock Box Terminal Source Code.” The software utilized by the distribution management system to control the delivery subsystem are filed herewith in Software Appendix E entitled “DMS Source.”

The multiplexer utilized within the delivery subsystem in connection with the preferred embodiment may be that disclosed in applicant's co-pending application entitled “Method and Apparatus for Dynamic Allocation of Transmission Band Width Resources,” filed Aug. 16, 1995 as a provisional application, Serial No. ______ (Attorney Docket 10872US01) and on Aug. 16, 1996 as a non-provisional application, Ser. No. ______ (Attorney Docket 10872US02).

All of the software appendices A through E referenced above, along with the above-referenced papers, provisional and non-provisional applications are expressly incorporated herein by reference in their entireties.

### FIELD OF THE INVENTION

The present invention relates generally to the distribution of live and recorded audio and, in particular, to an integrated distribution and playback system that provides distribution of digitized live audio, single audio files, and/or groups of audio files and playback instructions from a head end transmitter to one or more end user receivers.

### BACKGROUND OF THE INVENTION

Nationally syndicated radio programs and national advertizing campaigns make up a large part of the radio broadcasting industry. Current methods of distribution of these programs and advertisements to local broadcasting stations and subsequent production is surprisingly cumbersome and inefficient.

In one common scenario, a national broadcaster will offer a radio program to a local radio station. The station gets the program, and in return the national broadcaster is provided additional air time on the station to use for national advertizing spots. The national broadcaster then records an entire show that includes the radio program and national advertisements onto a compact disc, digital audio tape or the like. A compact disc or tape of the recorded show is then physically delivered to various local stations—usually by an overnight delivery service.

The recorded show is divided into segments, and between each segment is a gap which allows the local station to broadcast local spots such as local ads, station identification, or local news. Because the station operator needs to know when these gaps are going to occur and how long they will last, the national broadcaster must also provide a printed show format. The show format provides the station operator with information such as total show running length, out cues, and length of segment gaps.

To broadcast the show, the station operator plays the compact disc containing the prerecorded show while listening for out cues. When he hears an out cue he presses play on a playback device containing a recording of the local spot or gives the local newsperson the signal to begin speaking. The local spots are timed to end when the segment gap is over.

A number of problems are created for the national distributor using such a method of show distribution. The manufacture and recording of a compact disc for each local station is expensive and because the discs are usually only used once and then destroyed, this process is wasteful. Preparation of the compact discs and subsequent delivery can take up to a week. This time delay prevents distribution of shows that are up to date. Because the recordings must be physically sent to every local station, the cost of shipping is high. If national advertisers want to target only certain regions of the country with certain ads, different recordings must be made and shipped to stations in those regions.

At the local radio station, problems are created by the inflexible nature of a prerecorded show and the real time splicing of local spots into the broadcast based upon printed show formats and audible cues. These problems can cause wasteful dead air time and audibly unpleasant, abrupt changes between national and local segments.

### OBJECTS OF THE INVENTION

To overcome the problems and limitations of the prior art, the disclosed invention has various embodiments that achieve one or more of the following features or objects:

An object of the present invention is to provide an integrated system for the distribution and subsequent playback of high quality live audio, single audio files, and groups of audio files.

A further object of the present invention is to provide for selective distribution of live audio, single audio files, and groups of audio files to selected end users, or groups of end users based upon, for example, geographic region.

A still further object of the present invention is to accomplish data compression on audio signals to allow cost efficient transmission of live audio, audio files and groups of audio files without significant loss of audio quality.

A still further object of the present invention is to provide an integrated audio distribution and playback system that allows a user at a distribution center to control the order in which groups of audio files will be played by a distant playback machine.

A still further object of the present invention is to provide an integrated audio distribution and playback system that allows a user at the head end to produce a complete show for broadcast by local radio stations.

A still further object of the present invention is to provide an integrated audio distribution and playback system that allows local audio segments to be integrated into a show that is produced by a national distributer of audio segments.

A still further object of the present invention is to provide a playback system that produces audibly pleasing and smooth transitions from one audio file or segment to another audio file or segment.

A still further object of the present invention is to provide system components that are economical to manufacture and compatible with existing devices.

A still further object of the present invention is to provide a user friendly system with easy and flexible programmability.

### SUMMARY OF THE INVENTION

The preferred embodiment of the present invention includes an audio delivery system having, at a head end, a production subsystem which communicates with a delivery subsystem via a local area network, ISDN connection, and the like. The delivery subsystem communicates with an affiliate subsystem, at a tail end, via a satellite link, ISDN link and the like. The production subsystem enables a producer to create audio events which represent sequences of audio which are played to completion before another audio event occurs. Audio events are stored as audio files. Each audio event may include one or more of an audio sequence, text information, delivery instructions, and an attribute list having contact closure information and the like. optionally, multiple audio events may be assembled at the production subsystem to form a play list. The audio files are transferred to the delivery subsystem. The delivery subsystem places the audio files in delivery envelopes and transmits the envelopes to the affiliate terminals. In addition, the delivery subsystem may transmit live audio and related contact closure information to the affiliate terminals. The affiliate terminal may be located at a user site. The affiliate terminals may store these events on the hard drive, play the events in real time or pass events to other affiliate terminals. The affiliate terminal may later play stored audio events.

The audio delivery system of the preferred embodiment supports at least seven basic services. The audio delivery system enables audio files to be introduced into the system, along with auxiliary information about each file such as traffic information, formatics, incues, and the like. In addition, the audio delivery system enables bundling of audio events and supporting documentation into an aggregate delivery package, such as a play list. The bundled audio events and documentation are transmitted to desired affiliate terminals as a single package or envelope. Each package may be separately addressed to a particular affiliate terminal, and/or groups of affiliate terminals. This addressing information is referred to as delivery instructions. The audio delivery system further supports an integrity check to insure that packages are distributed properly.

### BRIEF DESCRIPTION OF THE DRAWINGS

FIG. 1 generally illustrates a block diagram of an audio delivery system according to the preferred embodiment of the present invention.

FIG. 2 generally illustrates a block diagram of a production subsystem utilized in connection with the preferred embodiment of the present invention.

FIG. 3 generally illustrates a block diagram of a delivery subsystem utilized in connection with the preferred embodiment of the present invention.

FIG. 4 generally illustrates an affiliate terminal utilized in connection with the preferred embodiment of the present invention.

FIG. 5 illustrates a perspective view of a remote affiliate remote control terminal utilized in connection with the preferred embodiment of the present invention.

FIG. 6 illustrates a block diagram of a digital audio card utilized in connection with the preferred embodiment of the present invention.

FIG. 7 illustrates a block diagram of a functional representation of a processor utilized in connection with the digital audio card used in the preferred embodiment of the present invention.

FIG. 8 illustrates a functional block diagram of the affiliate controller when operating in connection with a digital audio card used in connection with the preferred embodiment of the present invention.

FIG. 9 illustrates a block diagram of an audio file, cart file and play list file format.

FIGS. 10A and 10B illustrate a flow chart of the processing sequence followed by the digital audio card and an affiliate terminal to effect a playback operation.

FIG. 11 illustrates an exemplary cross fade operation between two stored segments followed by play of a local segment not stored on the affiliate terminal according to the preferred embodiment of the present invention.

FIG. 12 illustrates an alternative embodiment of the file delivery system of the present invention.

### DETAILED DESCRIPTION OF THE PREFERRED EMBODIMENT DEFINITIONS

Initially, a list of definitions is provided for commonly used terms.

| | |
|---|---|
| Audio Program - | One or more audio segments grouped |
| | on a playlist and delivered to at |
| | least one affiliate terminal. By |
| | way of example, an audio program may |
| | represent the Howard Stern show, |
| | Casey Cassims Top 40, and the like. |
| Audio Segment - | An audio event containing a |
| | continuous sequence of audio signals |
| | having defined beginning and ending |
| | points. The audio event is played |
| | by the affiliate terminal from |
| | beginning to completion before |
| | another event (audio or command) may |
| | occur. By way of example, an audio |
| | event may represent a sound bite, a |
| | song, a portion of a song, a portion |
| | of a syndicated show between |
| | commercials, a commercial and the |
| | like. |
| Audition Audio - | A short audio sequence |
| | representative of the content of an |
| | audio program. For instance, an |
| | audition audio signal may represent |
| | the first few seconds of a song and |
| | may be played to the affiliate |
| | terminal user to acquaint the user |
| | with the associated audio segment or |
| | audio program. |
| Cart Machine - | An audio playback device at an |
| | affiliate terminal used to play |
| | local audio segments, such as from |
| | tape. Cart machines are often used |
| | to record and play back commercials |
| | and news spots. |
| Cart File - | A file uniquely associated with an |
| | audio file. The cart file includes |
| | the audio file name, the starting |
| | and ending offsets into the audio |
| | file, marker attributes, incues, |
| | outcues death date and first use |
| | date. |
| Contact Closure | Instructions directing affiliate |
| Commands - | terminals to open or close contacts, |
| | such as to turn on and off cart |
| | machines. |
| Data Packet - | A segment of data passed through the |
| | multiplexer as a discrete unit, to |
| | which header information is attached |
| | prior to modulation and |
| | transmission. By way of example, |
| | audio segments and audio programs |
| | may be subdivided into data packets |
| | by the multiplexer and transmitted |
| | in a time division multiplexed |
| | manner to the affiliate terminal. |
| Death Date - | A preassigned date upon which an |
| | affiliate terminal automatically |
| | deletes an audio segment and/or |
| | audio program from the memory of the |
| | affiliate terminal. |
| Delivery | Instructions provided to inform the |
| Instruction - | delivery subsystem of which |
| | affiliate terminals should receive |
| | each data file during distribution. |
| Formatics - | The format or layout of an audio |
| | program which may be representative |
| | of a radio show. For example, the |
| | format may identify locations within |
| | an audio program at which a local |
| | affiliate station may insert local |
| | commercial spots. In addition, the |
| | format or layout would include |
| | incues and outcues for transitional |
| | segments and the play times for |
| | audio segments. |
| Out of Band | Control commands which may be |
| Control - | directed to an affiliate terminal as |
| | part of the multiplexer's internal |
| | communications, such as information |
| | identifying the channels over which |
| | a single message is being |
| | transmitted. |
| Playback List - | An outline or log, associated with |
| | a particular audio program, |
| | containing information uniquely |
| | identifying each audio |
| | segment/clip/event within the |
| | associated audio program. |
| Audio rules - | Recorded audio with no internal |
| | structure. Audio files may |
| | represent individual commercials or |
| | short or long form program segments. |
| Live audio - | Shows which are broadcast as they |
| | are received without recording the |
| | show on the affiliate terminal. |
| | Live audio may contain synchronized |
| | commands embedded therein within the |
| | ancillary data stream. The |
| | synchronized commands may be used to |
| | trigger affiliate functions, such as |
| | initiating commercial playback by a |
| | card machine at the affiliate |
| | terminal. |
| Delay Play | Shows which are recorded to disk but |
| Audio - | played back almost immediately |
| | (e.g., within five to ten minutes). |
| | The shows are recorded as received |
| | but the disk space is freed when the |
| | show is played. |

System Overview

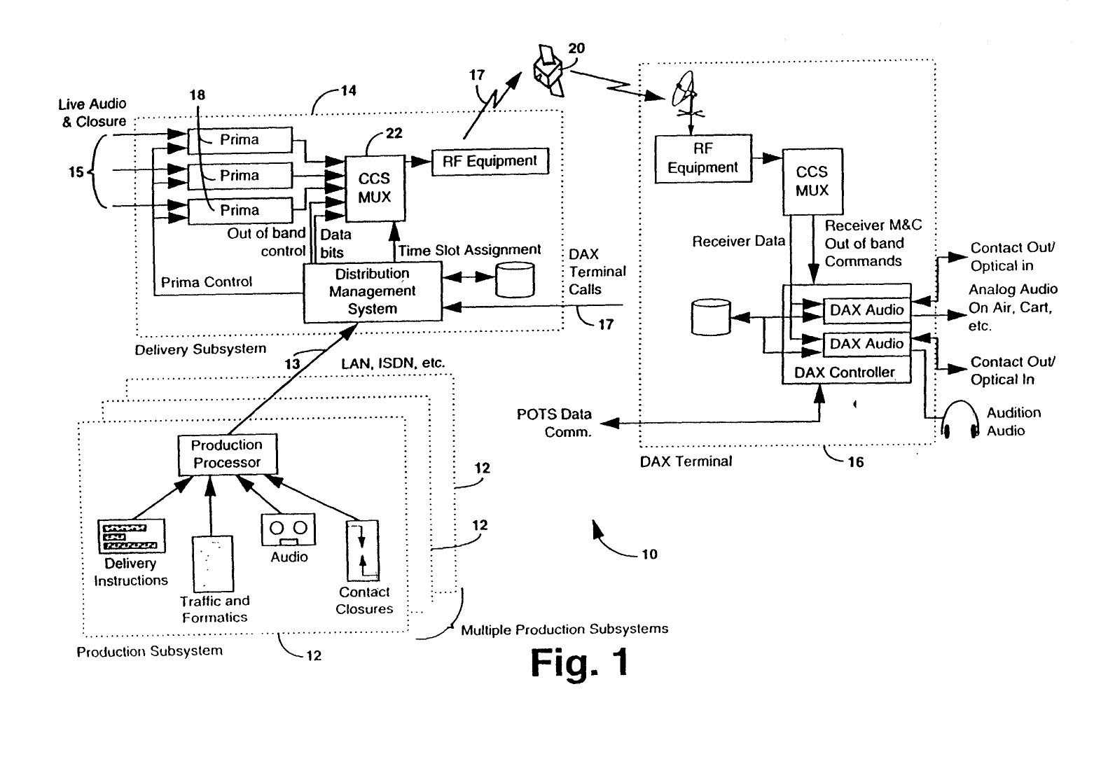

FIG. 1 illustrates a block of an audio delivery system 10 according to a preferred embodiment of the present invention. The audio delivery system 10 includes at least one production subsytem 12, at least one delivery subsytem 14 and at least one affiliate terminal 16. As shown in FIG. 1, each production subsytem 12 may communicate with one or more delivery subsystem 14 via any conventional medium which supports the transmission of digital data. By way of example, the interconnection (illustrated at line 13) between a production subsystem 12 and the delivery subsystem 14 may be a local area network, an ISDN link, a conventional telephone link, a satellite link and the like. As a further option, each delivery subsystem 14 may communicate with more than one production subsystem 12.

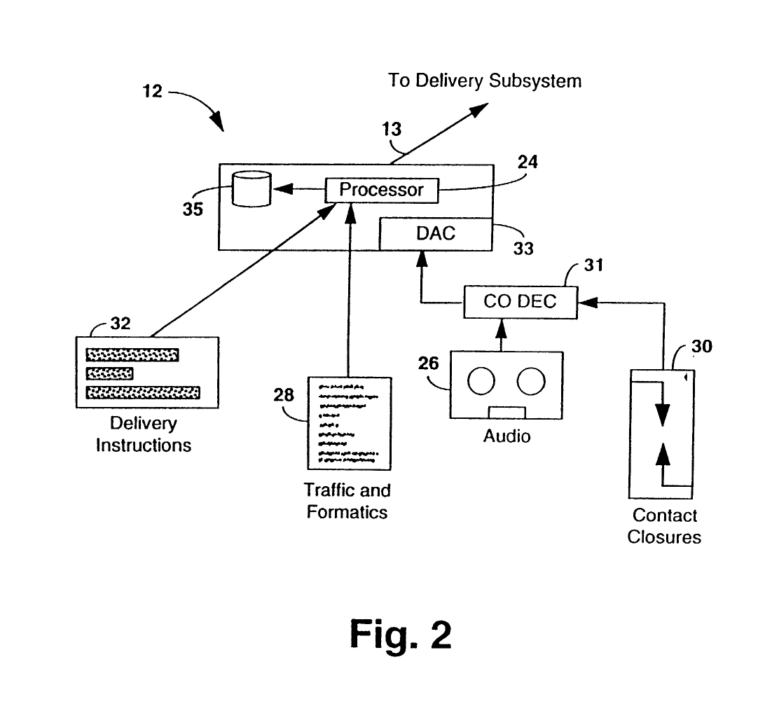

Each production subsystem 12 enables a user to produce data files, which generally refer to audio events/segments/clips, audio files, cart files, playback list files, text files, video files and delivery instruction files (as defined in the DEFINITIONS section). While the delivery and production subsystem are illustrated as functionally separate units in FIG. 2, both subsystems may be implemented at a comment site (and a common system), thereby avoiding the need for connection 13.

The delivery subsystem 14 receives audio files and sequences of audio files containing audio segments and audio programs, respectively, from the delivery subsystem 14 along link 13. In addition, the delivery subsystem receives live audio signals along links 15. The delivery subsystem 14 may also receive contact closure commands along links 15. The delivery subsystem 14 combines signals received upon link 13 and links 15 and outputs same via link 17 to the affiliate terminal 16. The link 17 may represent a satellite link, an ISDN link, and the like. Optionally, the delivery subsystem 14 may receive information from affiliate terminals via link 17 or link 19.

Optionally, the delivery subsystem 14 may assemble data files (e.g., audio files, cart files, commands, play list files, text files, video files and the like) into a single “envelope”. The “envelope” may include address information about the destination affiliate terminals. The delivery subsystem directs outgoing envelopes of audio files to individual affiliate terminals based on the address information. Optionally, the address information may designate a group of affiliate terminals as the destination for an envelope (e.g., midwestern radio stations for a syndicated show).

The affiliate terminal 16 receives incoming envelopes from the delivery subsystem 14 and processes same in a desired manner. Optionally, the affiliate terminal 16 may inform the delivery subsystem 14, via link 19, when the affiliate terminal 16 does not receive an expected audio file. The affiliate terminal 16 may store incoming audio files on a hard disk and replay these audio files later based on instructions (e.g., playback list) received with the envelope or based on instructions from an operator at the affiliate terminal. Alternatively, the affiliate terminal 16 may receive and immediately replay incoming audio data as received, such as during broadcast of live programs (e.g., the news). As a further alternative, the affiliate terminal 16 may interleave local programs (played from tape on local CART machines) and audio programs received from the delivery system 14 (stored on the hard drive) during a playback operation. The affiliate terminal 16 may utilize an automated cross fading operation when mixing an ending portion of one audio segment and a beginning portion of a next audio segment.

The auxiliary terminal 16 outputs analog audio signals over link 19 to be broadcast from the radio station. Lines 21 and 23 support outgoing contact closure commands, such as transmitted from the affiliate terminal 16 to a CART machine. Line 23 receives sensor input signals such as to inform the affiliate terminal 16 of the present state of a CART machine and the like. The affiliate terminal 16 outputs audition audio signals over line 25 to a user at the affiliate terminal.

Data Format

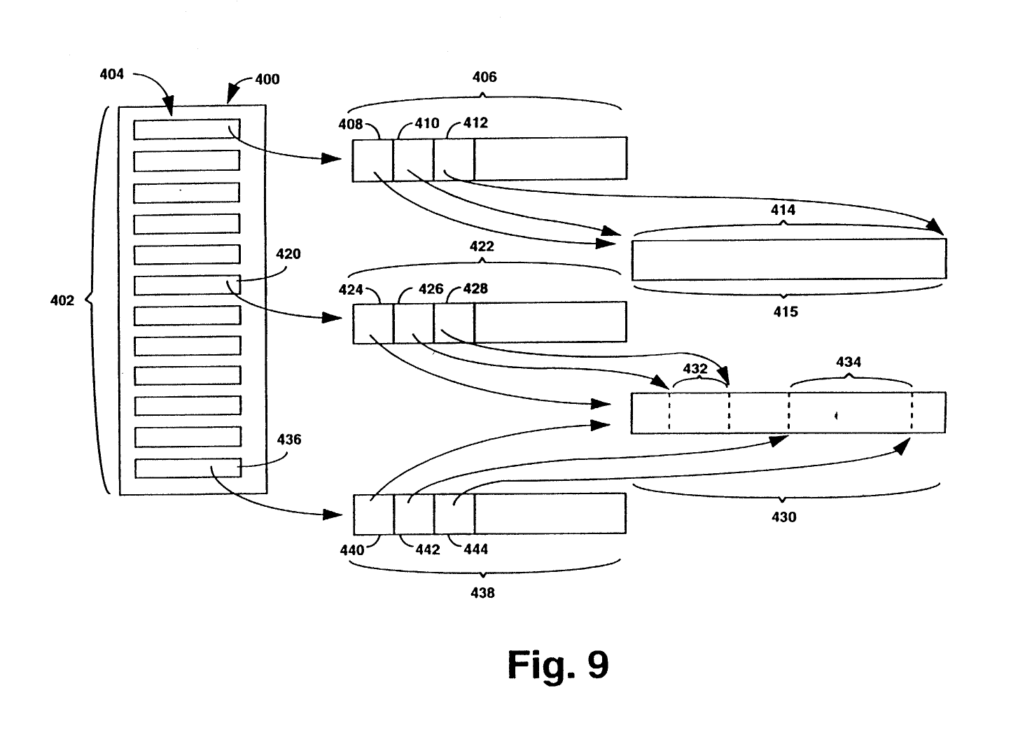

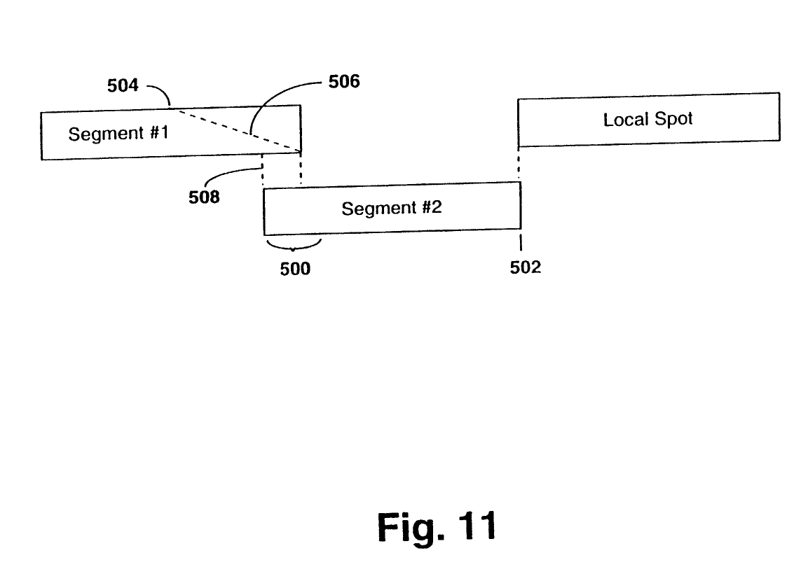

FIG. 9 generally illustrates an exemplary data format for use in connection with the preferred embodiment of the present invention. While it is understood that the present invention is not limited to audio data production and transmission, for purposes of illustration, it is assumed that an audio program is produced and transmitted. FIG. 11 illustrates a play list file 400 that defines a program of audio segments. The audio segments in the play list file may be displayed to the user in an outline format. The play list file 400 may include a play back list 402 of file names (e.g., 404, 420 and 436) identifying each audio segment to be played. The file names 404, 420 and 436 represent file names and directory paths to cart files 406, 422, and 438, respectively. Each cart file 406, 422 and 436 uniquely identifies an audio segment 414, 432 and 434, respectively. Each cart file 406, 422 and 438 includes a path name 408, 424 and 440, respectively, to an audio file 415 and 430 containing a corresponding audio segment. Audio file 430 includes the audio segments 432 and 434 for cart files 422 and 438.

Each cart file (406, 422 and 438) also includes beginning (410, 426 and 442) and ending data frame numbers (412, 428 and 444) into the corresponding audio file. The beginning and ending data frame numbers identify the starting and ending points of the corresponding audio segments. Each cart file may also include attributes for a corresponding audio segment, such as markers (used to initiate DAC events as described below), incues, outcues (to tell the user when a segment will end), text description (comments describing an audio segment), death date (the date upon which the affiliate automatically deletes the audio file), and first use dates (the date upon which the affiliate terminal will first be allowed to access the audio segment).

During operation, text, outcues, comments and the like may be obtained from the audio files, cart files and play list files and displayed to the user. This display may include the display of a playback list by audio segment title, along with breaks for local spots and segment play times.

Production Subsystem

FIG. 2 illustrates the production subsystem 12 in more detail. The production subsystem 12 includes a production processor 24 which communicates with a delivery instruction input unit 32, a traffic and formatics input unit 28, an audio input unit 26 and a contact closure input unit 30. The delivery subsystem includes a hard drive 35 for storing audio files associated with audio segments and audio programs prior to transmission to the delivery subsystem 14. The audio and contact closure inputs 26 and 30 supply audio and contact information signals to a CODEC 31, such as the CDQ prima coder/decoder which is commercially available from Corporate Computer Systems, Inc., located in Holmdel, New Jersey. The CODEC 31 may encode the incoming audio signals based on a number of conventional “lossy-type” encoding algorithms such as the MUSICAM algorithm which is commercially available from Corporate Computer Systems, Inc. optionally, a different encoding algorithm may be used in the CODEC 31.

The CODEC 31 further receives contact closure instructions from the input 10 and incorporates these contact closure instructions into the output encoded audio signal. The output of the CODEC 31 is supplied to a digital audio card (DAC) 33, which is explained in more detail below in the section entitled DIGITAL AUDIO CARD. The DAC 33 relays the encoded audio data and contact closure data to the processor of the delivery subsystem 12 for temporary storage while delivery instructions and traffic/formatics information are produced and attached thereto. The DAC 33 may decode the output signal from the CODEC 31 and play the decoded audio signal to the user to enable the user to hear the resultant audio signal once encoded and decoded according to a current set of compression parameters.

Optionally, the producer may initially listen to the decoded output of the DAC 33 without recording the encoded audio signal from the CODEC 31 , such as to determine whether the current parameter settings of the CODEC 31 need to be changed. Once the parameters of the CODEC 31 are set to the satisfaction of the producer, the producer may select a record option. Responsive thereto, the production processor 24 and the DAC 33 cooperate to record the encoded audio output signal from the CODEC 31 on the hard drive of the delivery subsystem 12. As a further option, while recording, the DAC 33 may be switched to turn the playback operation off.

As a further alternative, the DAC 33 may be instructed to pass a new incoming encoded audio signals from the CODEC 31 to the processor 24 for storage on the hard drive, while simultaneously reading a previously encoded audio signal from the hard drive of the delivery subsystem 12. The DAC 33 may decode and play the previously stored audio program to the producer while a new audio program is being encoded by the CODEC 31 and stored on the hard drive. In this manner, the delivery system of the preferred embodiment supports simultaneous recording and editing operations of first and second audio programs, respectively.

Optionally, the processor 24 may attach delivery instructions and traffic and formatics to audio segments and audio programs when stored in the data base 35. Once an audio segment or program is completed, the producer may instruct the processor 24 to transmit the audio segment or program over link 13 to the delivery subsystem.

By way of example only, the production subsystem 12 may be located in an advertising agency which will produce commercials for a national broadcaster. Using this approach, the agency may perform the production function, and the resulting audio programs may be sent directly to the delivery subsystem 14 via ISDN links and the like without further involvement of the national broadcaster.

By way of example only, the audio input 26 may represent a digital audio tape player, a compact disk player and the like. The system may also support direct digital inputs such as AES/EBU. The traffic input may constitute a keyboard for entering a simple play instruction or a complex outline of an audio program including incues, outcues and the like. The contact closures may be used to start and stop CART machines and the like as explained below. The delivery instruction input 32 enables the programmer to input all information required to deliver an audio program to a desired affiliate terminal or group of terminals. The delivery instructions may include the name of the intended affiliate terminal, group of affiliate terminals, the name of the sender, the relevant billing information, termination data and the like.

By way of example only, the production subsystem may include the PACE system which was commercially available from New Jersey and is now used by CBS.

Delivery Subsystem

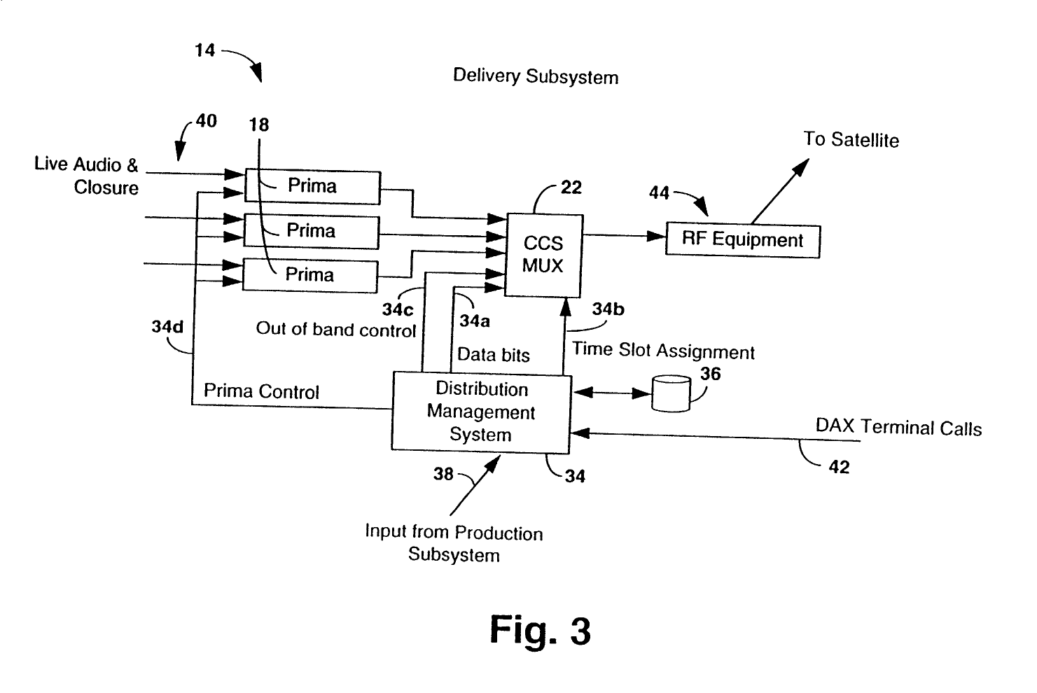

FIG. 3 generally illustrates the delivery subsystem in more detail. The delivery subsystem 14 includes a distribution management system 34 (DMS) which receives data files, such as audio files, cart files, play list files, command files, text files, video files and the like from the production subsystems 16. The DMS 34 may receives communications from affiliate terminals along line 42, such as status reports, billing reports, delivery confirmation of data files and the like. Optionally, the DMS 34 may receive delivery instructions from the production subsystem. The delivery subsystem 14 collects incoming data files and may assemble these data files into “envelopes” containing commonly addressed data files, address information for destination affiliate and/or hub terminals, address information for destination groups of affiliate and/or terminals, priority delivery information regarding the latest delivery time of the envelope, a routing path list identifying each affiliate/hub terminal that has already received the envelope and the like.

The DMS 34 passes the envelope to the multiplexer 22 along data line 34a. The multiplexor 22 may divide the envelope into records for transmission along one or more channels. Optionally, the DMS may control operation of the multiplexer 22 via time slot control line 34b. The DMS 34 may also pass commands, intended for affiliate and/or hub terminals, along an out of band control line 34c to the multiplexer 22.

Alternatively, the multiplexor 22 may be controlled by a separate processor, in which case the DMS 34 would connect with the multiplexor 22 solely through a data output line 34a. The out of band control line 34c and time slot assignment line 34b would be driven by the separate processor controlling the multiplexor 22.

As a further alternative, the production subsystem 12 may directly control addressing of the delivery subsystem 14, in which case the DMS 34 would pass data files to the multiplexor 22 without addressing information therewith and without grouping the data files into “envelopes”.

The delivery subsystem 14 may include at least one CODEC 18 for receiving live analog audio signals along lines 40 and encoding same based on one of several known encoding algorithms. The DMS 34 controls operation of the CODECs 18 via a control line 34d. The multiplexer 22 receives digitally encoded audio signals from the CODECs 18. The multiplexer 22 operates in a manner set forth in the above referenced co-pending application (incorporated by reference) to pass incoming data along one or more transmission channels to a modulator 44. The modulator 44 may transmit signals received from the multiplexer 22 to a satellite.

In the foregoing manner, the delivery subsystem 14 collects data files including audio files, cart files, play list files, command files, text files, video files and distribution information from the production subsystem. The delivery subsystem 14 further receives live audio signals and ancillary data, such as contact closure information, via CODECs 18. Data is transmitted to affiliate and/or hub terminals via a desired medium. While in the preferred embodiment, the delivery subsystem utilizes a satellite connection to transmit data to affiliate terminals, the present invention is not so limited. Alternatively, the delivery subsystem 14 may transmit data along any medium which supports transmission of digitally encoded data at a transmission rate dictated by the particular application. For instance, the delivery subsystem 14 may transmit the digitally encoded data along ISDN lines, and the like. When low transmission rates are acceptable, the delivery subsystem 14 may utilize conventional telephone lines to transmit the digital data.

Affiliate Terminal

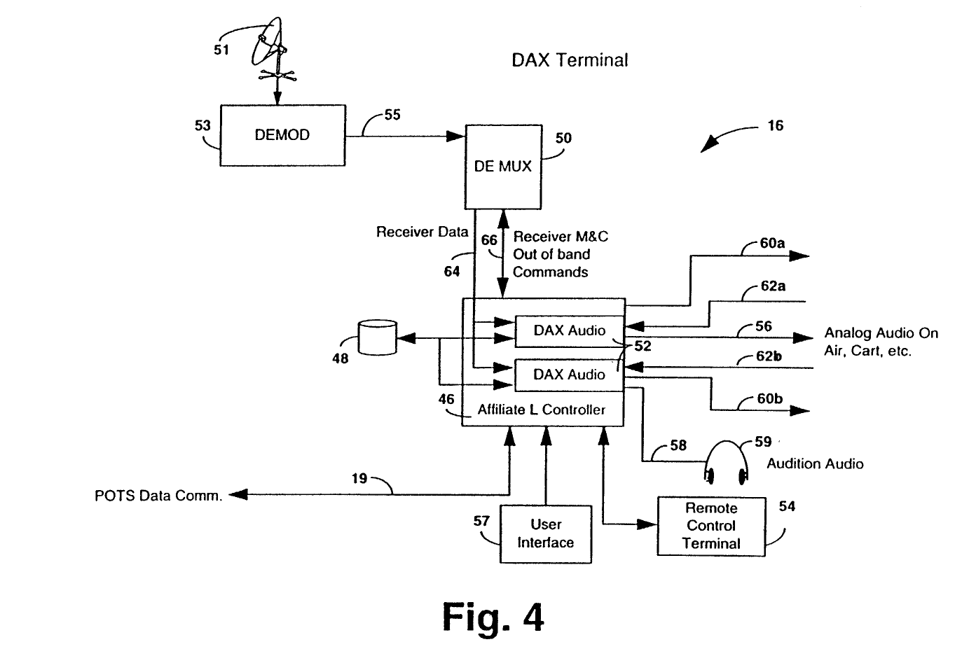

FIG. 4 illustrates an affiliate terminal 16 in more detail. The affiliate terminal 16 may be located at a receiving station or end user site. The affiliate terminal 16 includes an antenna 51 for receiving incoming live data rackets, data files and envelopes via satellite 20 from the delivery subsystem 14. Optionally, the antenna 51 may transmit return information, such as delivery information that an audio program has or has not been received. Incoming information is demodulated in an RF demodulator 53 and passed to a demultiplexer 50. The demultiplexer 50 is configured to be compatible with the multiplexer 22 of the delivery subsystem 14. The demultiplexer 50 may demultiplex incoming data records from one or more channels to reassemble at least one envelope. The demultiplexer 50 may also demultiplex output out of band commands along line 66. Optionally, the demodulator 53 may be controlled to receive real time live audio data encoded, but not formatted into audio files (as described above). The encoded audio data is received as a continuous data stream of data packets of data frames. When the demultiplexer 53 is configured to receive a live audio data stream, the DAC 52 is set in a “live mode” to receive the data stream. In this manner, the encoded data stream of live audio data is decoded and played back in real time.

The affiliate terminal further includes an affiliate controller 46 which receives data files, such as audio files, cart files, play list files, text files, video files, and commands from the demultiplexer 50. The affiliate controller 46 may represent a personal computer running a conventional operating system, such as Windows 95 offered by Microsoft. The affiliate controller 46 may store the incoming data on a memory 48. The affiliate controller 46 includes at least one digital audio card (DAC) 52, explained below in more detail.

The affiliate terminal 16 outputs an audio signal over at least one of an analog output line 56 for broadcast by the station or over a digital output line via an AES/EBU line. The affiliate terminal 16 may include an audition audio output line 58 from DAC 52 which enables an affiliate user to listen to at least a portion of audio segments or audio programs stored on the memory 48. A remote control terminal 54 may be provided to afford the affiliate user remote control over at least a subset of the functions performed by the affiliate controller 46. By way of example, the remote control terminal 54 and audition audio headset 59 may be located in the DJ's booth at a radio station to enable the DJ to audition, listen to, and control play of audio segments and programs stored on the memory 48. The remote control terminal 54 enables the DJ to select desired audio segments and programs stored on the memory 48 from within the DJ's booth even though the affiliate controller 46 is located remote from the DJ's booth.

Lines 60 and 62 represent contact output control lines and sensor input lines, respectively, and are driven and sensed by the DAC 52. The sensor input lines 62 may be optically isolated input lines. The DAC 52 outputs contact open and close signals over contact output lines 60. The DAC 52 monitors sensor input lines 62 in order to detect a change in state (i.e., open or close) of a remote device. The remote device may represent a cart machine, a remote control terminal and the like. By way of example, sensor inputs 62 may monitor a cart machine to inform the DAC 52 when a cart machine completes play of a local program.

A user interface 57 may be provided to control the affiliate controller 46. By way of example, the user interface 57 may include a keyboard, a mouse and a display, while the affiliate controller 46 operates in a Windows environment in which icons may represent audio segments and/or programs, and functions (e.g., record, play, fade, stop and the like). The user may perform a desired function upon an audio segment or program by clicking, dragging and dropping the associated icons.

Digital Audio Card

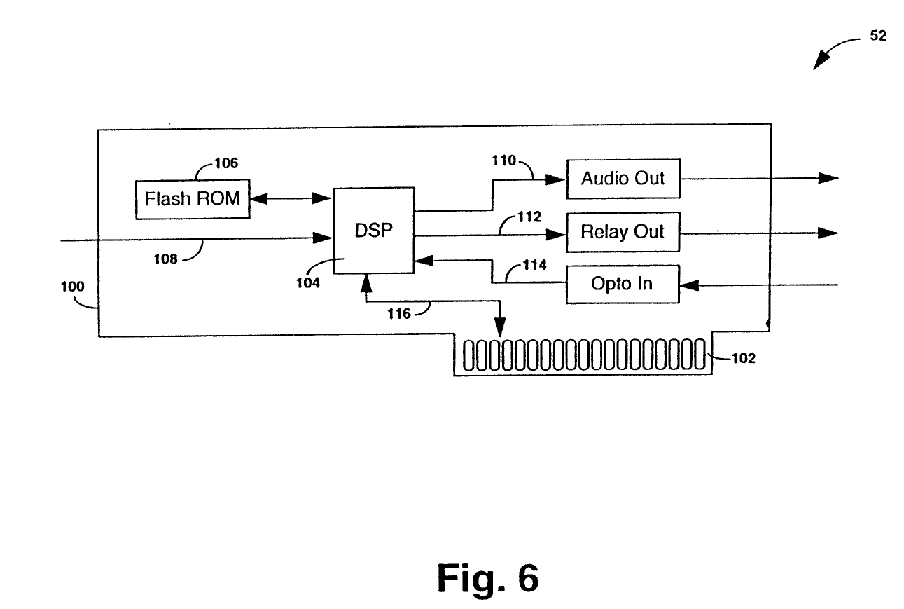

FIG. 6 illustrates a digital audio card (DAC) 52 utilized in connection with the preferred embodiment of the present invention. The DAC 52 may be implemented on a printed circuit board 100 having an interconnection port 102 for connection with the mother board of the affiliate terminal 16. The DAC 52 may be implemented with a digital signal processor (DSP) 104 which operates as explained below. While the preferred embodiment uses a DSP, it may be implemented with a dedicate chip or a general purpose microprocessor available commercially from Intel Motorola, CYRIX, AMD and the like. Memory 106 stores the command software which controls operation of the digital signal processor (DSP) 104. The DSP 104 receives incoming data files and commands upon line 108 (from lines 64 and 66 from the demultiplexer 50 in FIG. 4). The DSP 104 outputs decoded audio signals along line 110. The DSP 104 informs the affiliate controller 46 when a “marker” occurs during play of a segment (markers are explained below). If the marker corresponds to a contact closure command, the affiliate controller 46 instructs the DSP 104 to set the relay output signal (e.g., contact closure signal) along line 112. The DSP 104 receives sensor status information along the sensor input 114 and relays this sensory information to the affiliate controller 46. The DSP 104 communicates with the affiliate controller 46 along line 116.

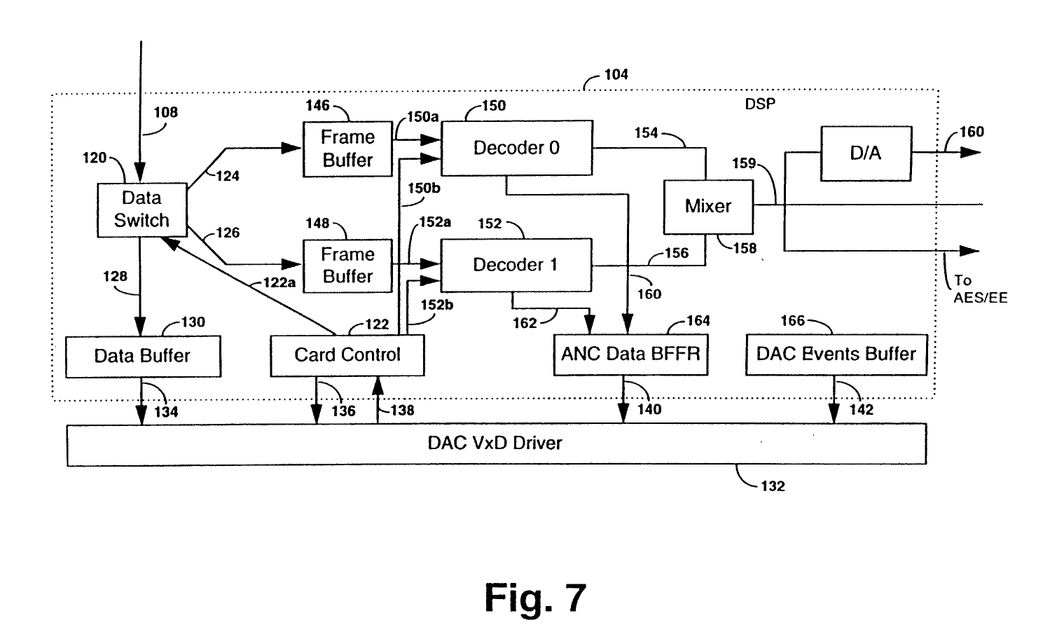

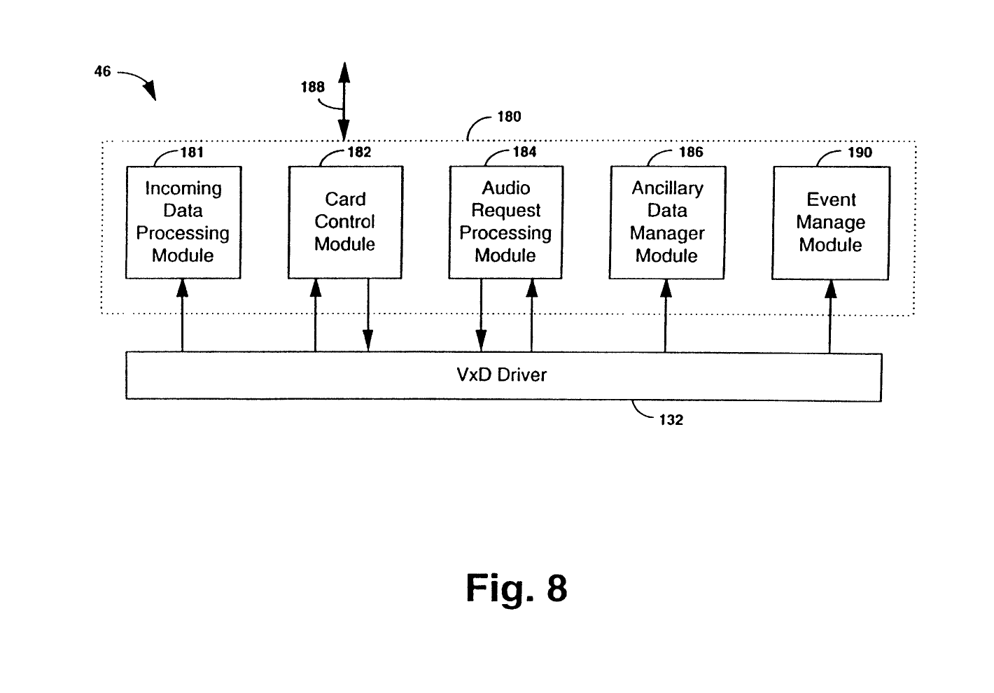

Next, the discussion turns to FIG. 7 which illustrates a functional diagram representative of the operations performed by the DSP 104 in the DAC 52. The functions of the DSP 104 include a data switching operation 120 which receives incoming envelopes, data files and frames along line 108 including audio files, cart files, play list files, command files, live data frames and the like. The data switch 120 only admits envelopes, data files and frames which are addressed to the particular DAC card 52. The data switch 120 disregards incoming information not addressed to the particular DAC card 52. The data switch 120 outputs the envelopes and data files to line 128 and the live data frames to one or more of lines 124 and 126. The data switch 120 is controlled by the card controller 122. Envelopes and data files passed along line 128 are temporarily stored in a data buffer 130 prior to transmission to the affiliate controller 46, (FIG. 4) along line 134 through a DAC driver 132. The DAC driver 132 communicates with the DSP 104 along lines 134, 136, 138, 140 and 142. The DAC driver 132 communicates with the affiliate controller 46 as explained in connection with FIG. 8. The DAC driver 132 represents a low level hard drive interface connecting the DAC 52 with the application, and may be omitted or varied dependent upon the application.

The data switch 120 delivers a stream of live encoded audio data along lines 124 and 126 to frame buffers 146 and 148. During a live play mode, one of frame buffers 146 and 148 temporarily store encoded incoming audio data while outputting (in a first-in-first-out manner) individual data frames to decoders 150 and 152 along lines 150a and 152a. The decoders in turn decode data frames of audio data and output decoded digital audio data along lines 154 and 156 to a mixer 158. The mixer 158 combines the digital audio data upon lines 154 and 156 and outputs the resultant audio signal along line 159.

The data frames correspond to a predefined discrete amount of encoded digital audio data. For instance, the encoder may perform encoding upon a 24 millisecond interval of digitized audio information. The 24 millisecond discrete section of digitized audio data is output by the encoder as an encoded data frame. Multiple frames of data are combined to form an audio stream.

As explained below, the card controller 122 may also supply sets of data frames from audio files stored on the memory 48 to decoders 150 and 152 along lines 150b and 152b.

Data frames decoded by the decoders 150 and 152 may also contain ancillary data, in which case the decoders 150 and 152 output the ancillary data along lines 160 and 162 to the ancillary data buffer 164. The data buffer 164 temporarily stores the ancillary data until output along line 140 through the DAC driver 132 to the affiliate controller 46.

DAC Events Buffer

The DAC events buffer 166 stores messages of interest to the affiliate controller 46. By way of example, the DAC event buffer 166 may store a message indicating when an audio segment has ended and identifying the segment by event number. optionally, the event buffer may store messages indicating when markers occur during playback of an audio segment. A marker may represent a flag preassigned by the producer at the production subsystem. As an audio segment which contains a marker is played, upon detection of the marker during playback, the DSP stores, in the event buffer, a message indicating that the marker has occurred. Markers may be used to turn on and off contact closures. Thus, markers may be added to automatically control a local cart machine by introducing a marker into an audio program. During play of the program, when the marker is detected, the affiliate controller 46 is informed of the marker and the affiliate controller 46 outputs a corresponding contact closure signal. By way of example, a marker #1 may instruct the affiliate controller 46 to close a contact, while a marker #2 may instruct the DSP 104 to begin a cross-fade operation.

In addition, the DAC event buffer 166 stores sensor input messages received upon sensor input lines 62 (FIG. 4) by the DAC card. When the cart machine is instructed to begin automatic play by automatically closing a contact, a sensor proximate the contact will detect when the audio segment played by the cart machine ends.

DAC Processor Operation

Next, the operation of the DSP 104 is explained in more detail.

Initially, the data switch 120 monitors the line 108 to determine when an input is present. When this condition is satisfied, the data switch 120 accesses the incoming data to determine the DAC address therein. The data switch 120 compares this incoming DAC address to an address provided along line 122a from the card controller 122. If the DAC address of the present DAC corresponds to that of the incoming data, the data switch determines that the incoming data is intended for this DAC. Optionally, when the address of the incoming data represents a group address, the data switch 120 determines whether the present DAC has been assigned to the group. The card controller 122 informs the data switch 120 of the group addresses to which the DAC has been assigned. If the incoming message is not addressed to the present DAC or to a group containing the present DAC, the data switch disregards the data.

When incoming data is addressed to the present DAC or a group containing the present DAC, the data switch 120 passes the data to one or more of lines 124, 126 and 128 based on a control signal from the card controller 122. For instance, during a live play operation, the data switch 120 delivers incoming audio data along line 124 to frame buffer 146 for temporary storage. The frame buffer 146 delivers each data frame to the decoder 150 for decoding and output as n digital audio signal. The output of the decoder 150 may pass through a digital to analog converter to be output to line 160 and ultimately output at line 56 (FIG. 4) from the affiliate controller 46 as the analog audio signal to be broadcast.

Alternatively, during a storage operation, the incoming data files pass through the data switch 120 along line 128 to the data buffer 130. The data buffer 130 temporarily stores the data files until passing the audio data along line 134 through the DAC driver 132 and ultimately to the memory 48 of the affiliate controller 46. Optionally, the affiliate user may instruct the DSP 104 via the card controller 122 to direct incoming audio data along lines 128 and 124 in order that audio data may be recorded (via data buffer 130) and simultaneously listened to by the user (via frame buffer 146 and decoder 150).

Affiliate Controller

FIG. 8 generally illustrates a functional diagram of the modules of the affiliate controller 46 used in connection with the DAC 52. The affiliate controller 46 communicates with the DAC 52 via the virtual DAC driver 132. The affiliate controller 46 may be configured to include an audio server 180 having multiple internal modules that interface with DSP 104 (as explained above).

The audio server 180 may include an incoming data processing module 181 which processes data files (e.g., audio files, cart files, play list files, video files, text files) received from the data buffer 130 (FIG. 7). The incoming data processing module 181 stores these files on the memory 48. The audio server 192 may include a card control module 182 for communicating with the card controller 122. The card control module 182 and the card controller 122 pass command data therebetween, including requests, responses, polling commands and the like. An audio request processing module 184 may be provided to service data requests from the card controller 122. As explained below in more detail, the audio request processing module 184 obtains data frames from the memory 48 and passes these data frames to one of the decoders 150 and 152 during a playback operation.

An ancillary data manager module 186 and event manager module 190 may also be provided to receive ancillary data and event messages from the ancillary data buffer 164 and the event buffer 166, respectively. The ancillary data and event manager modules 186 and 190 direct incoming data and messages to the appropriate module within the audio server 180 for storage and processing.

The audio server 180 provides control over playback, sensor inputs, contact closure outputs and the like. The audio server 180 affords an interface with affiliate users via communications link 188. In this manner, the affiliate user may instruct the audio server 180 to perform the above discussed functions afforded by an affiliate terminal. optionally, the link 188 may enable a remote control terminal 54 to input control request of the audio server 180, and thus to the affiliate terminal 16.

The audio request processing module 184 provides an interface between the audio files stored on the memory 48 of the affiliate terminal and the DAC 52. As explained in more detail below, the audio request processing module 184 includes a buffer which stores data frames from an audio file stored on the memory 48 in order to provide data frames from the audio file to the DAC 52.

The audio server 180 provides a common point for all interface applications to interact with the affiliate terminal. The audio server 180 represents a multifunctional server which enables users (e.g., interface clients) to attach thereto via several links (e.g., LAN, serial and the like). The users send requests to the audio server and receive responses therefrom via link 188. The audio server 180 manages multiple users accessing the same pool of affiliate of terminal resources (e.g., audio files, playback devices such as cart machines, relay closures and the like).

The virtual DAC driver 132 passes data frames from the DAC 52 to the memory 48 (during a storage operation) and from the memory 48 to the DAC 52 (during a playback operation). The driver 132 also passes commands in both directions. In connection with the playback operation, the DAC 52 signals the driver when the DAC 52 needs additional data. The DAC 52 identifies the data by a unique identifier (segment handle).

Playback of Stored Segment

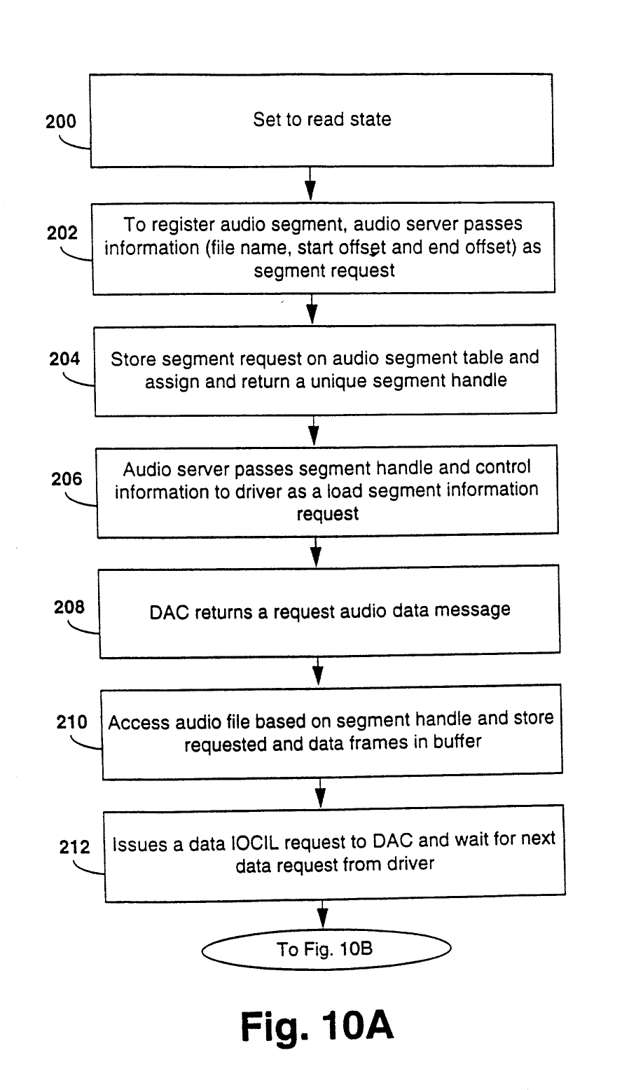

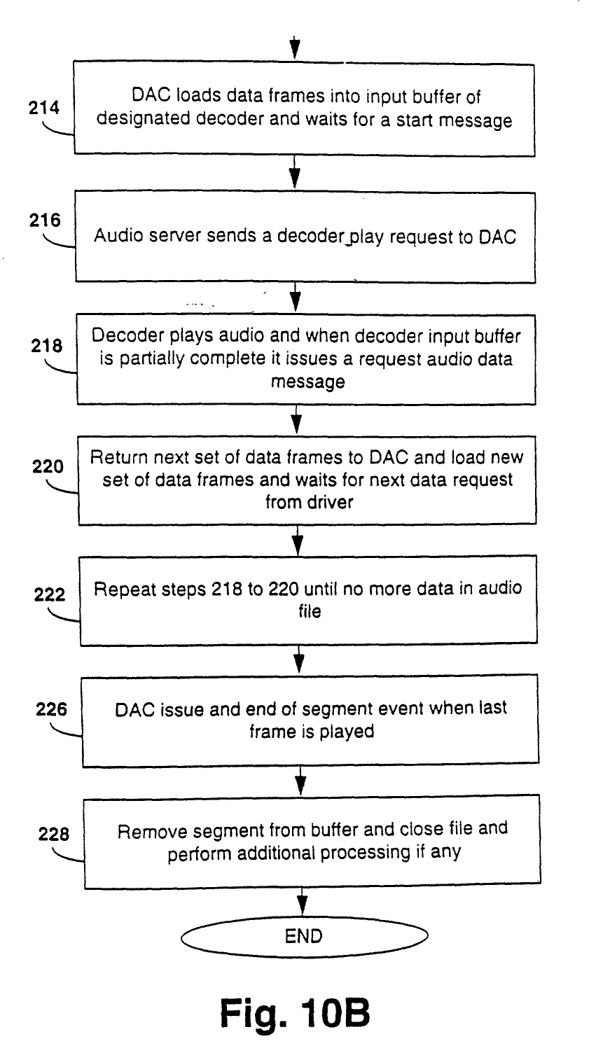

Next, the discussion turns to FIGS. 10a and 10b which illustrate the processing sequence followed by the affiliate controller 46 and DAC 52 in connection with the playback operation. The audio server 180 receives a playback instruction (such as from a user via link 188 or from a remote device via a sensor input 62). Initially, the audio request processing module 184 is set to a read state to wait for driver request signals. The audio server 180 registers one or more audio segments with the audio request processing module 184 (step 202). To effect registration, the audio server 180 passes data file information to the audio request processing module 184 such as information in cart files, which may include a name of a data file containing the audio segment or segments to be played. In addition, the audio server 180 passes a start offset and end offset into the audio file to the audio request processing module 184. The data file information are passed as a segment request to the audio request processing module 184 which stores the segment request on an audio segment table and assigns a unique segment handle (e.g., a unique number) to the segment request. The segment handle is stored with the segment request in the audio segment table (step 204).

The audio request processing module 184 returns the unique segment handle to the audio server 180. Thereafter, the audio server 180 passes the segment handle and additional control information to the DAC 52 as a load segment information request signal (step 206). The additional control information may include, for example, an identifier designating which of the decoders are to be used, segment start options, start fading time, end fading time, event markers, a start trigger and the like. The load segment request is passed to the card controller 122 (FIG. 7) and the card controller 122 stores at least the unique segment handle.

At step 208, the DSP 104 returns a request audio data message including the segment handle to the audio request processing module 184. Upon receipt of this message, the audio request processing module 184 accesses the audio file identified in the audio segment table by the segment handle (step 210). The audio request processing module 184 reads a set of data frames from the audio file and transmits these data frames to the DAC 52. At step 212, the audio request processing module 184 waits for a next data request from the DAC 52.

Turning to FIG. 10b, the DAC 52 loads the data frames received from the audio request processing module 184 into an input buffer of the designated decoder (step 214). The DAC thereafter waits for a start message before beginning the decoding operatioh. At step 216, the audio server 180 sends a decoder play request to the DAC 52. The decoder begins decoding and outputting the digital audio signal (step 218). When the decoder has completed decoding a predetermined portion of the data frames in the decoder input buffer, the DAC 52 issues a request audio data message to the audio request processing module 182. At step 220, the audio request processing module 184 reads the next set of data frames from the hard drive and writes this new set of data frames to the DAC 52. The audio request processing module 184 again enters a wait state to wait for a next data request from the DAC 52. Steps 218 and 220 are repeated until the desired segment or segments from the audio file are read by the audio request processing module 184, passed to the DAC 52 and output as audio signals or until user intervention.

At step 226, the DAC 52 issues an end of segment event when the last data frame stored in the decoder input buffer is decoded and played. Upon receipt by the audio request processing module 184 of the end of segment event, the audio request processor (at step 228) clears the last set of data frames from its buffer and closes the audio file. In addition, the audio server 180 performs any additional processing which is necessary upon completion of the playback operation of the audio segment. These additional operations may include cleaning up tables, notifying user, closing and opening contact relays and the like.

Automatic Playback of Local Spots with Stored Segments

Next, an example is described whereby, during playback of an audio program stored on the memory 48, local audio segments are automatically played by a cart machine. The audio segment stored on the memory 48 is played by the DSP 104 according to the playback operation described above. By way of example only, the stored audio program may include two audio segments (national segment #1 and national segment #2) which are to be separated by two local segments (local segment #1 and local segment #2).

Initially, national segment #1 is read from the memory 48 and supplied to the DSP 104 in sets of data frames. A marker attribute is assigned to national segment #1 indicating that a contact should be closed upon completion of the national segment #1 in order to start the local cart machine (which contains the local segment #1). As the DSP 104 processes the first national segment, it identifies the marker attribute, after the appropriate offset time, writes a marker attribute message to the DAC event buffer 166, such as the marker number. The affiliate controller 146 reads the marker attribute message (marker number) from the event buffer 166 and, responsive thereto directs the DAC 52 to output a contact closure signal upon line 60 (FIG. 4) instructing a first cart machine (containing local segment #1) to begin play. The DAC 52 then polls a sensor input line 62 from cart machine 1. Upon completion of the local segment in card #1, the cart machine is stopped and a contact open signal is returned upon sensor input signal 62. The return signal from sensor input 62 informs the affiliate controller 46 that the cart machine is either completed play of the local segment or about to complete play of the local segment (e.g., within the next 30 seconds). Responsive to the input along sensor input line 62, the affiliate controller 46 instructs the DSP 104 to begin play of the next national segment #2. The affiliate controller 46 loads the national segment #2 into the DSP 104 in the manner explained above upon completion of the first local segment.

In the present example, a marker attribute #2 is assigned to national segment #2 indicating that a second local segment should follow Completion of the second national segment. As the DSP 104 processes the second national segment, the DSP 104 writes the second marker attribute message to in the data event buffer 166 at a predefined time during play of the second national segment. The affiliate controller 46 reads the second marker attribute from the buffer 166 and instructs the DSP 104 to output a second contact closure signal upon line 60b. The contact closure signal upon line 60b instructs a second cart machine to begin play of a second local segment. As above, when the second cart machine reaches the end of a second local segment, the second cart machine outputs a sensor input signal upon line 62b instructing the DSP 104 that the second local segment is complete. Optionally, the second cart machine may supply the sensor input along line 62b a predefined period of time before completion of the second local segment (e.g., 30 seconds). In this manner, the affiliate controller 46 may automatically cross-fade national and local segments.

Cross Fading

FIG. 11 illustrates a block diagram representative of a cross fade operation between two audio segments stored in memory 48, followed by a local spot played by a cart machine. For purposes of this example, it is assumed that the play list includes the following cart file names and instructions on when to begin play of the cart file:

Segment #1—Start Option, Manual

Segment #2—Start Option, Marker 2

Local Spot #1—Start Option, Marker 1

It is further assumed that the cart files for segments #1 and #2 and local spot #1 include at least the following attributes:

Segment #1

Start Offset 0

End Offset 2000

Marker 2, 1900

Audio File Name #1

Segment #2

Start Offset 400

End Offset 3000

Marker 1, 3000

Audio File Name #2

Local Spot #1

Contact Closure, Cart 1

Sense Play End, Cart 1

Returning to FIGS. 7 and 8, during operation, the audio request processing module 184 initially passes to the card control 122 the segment handle and corresponding list of attributes for segments #1 and #2. Segment #1 extends from location 0 through 2000 in audio file #1 (e.g., each location may correspond to a data frame). Segment #2 extends between locations 400 and 3000 in audio file #2.

The audio request processing module 184 obtains a first set of data frames for segments #1 and #2 from the memory 48 and passes the sets to the card control 122. The sets of data frames are stored in buffers in the first and second decoders 150 and 152, respectively. The first decoder 150 begins processing the data frames from segment #1. The audio request processing module 184 provides new data frames from segment #1 as needed by the first decoder 150. When the first decoder 150 reaches location (e.g., data frame) 1900, the DSP 104 detects the Marker #2. Responsive thereto, the second decoder 152 begins decoding the first set of data frames from segment #2. In this manner, the first and second decoders 150 and 152 simultaneously output digital data, as shown in FIG. 11 at cross fade region 500. In the cross fade region 500, the mixer 158 reduces the amplitude of the audio segment #1 and increases the amplitude of the audio segment #2 to mix the two segment outputs as provided to the broadcaster at point 160 and/or to an AES/EBU output.

Optionally, a second marker event (e.g., Marker 1, 1600) may be added to the cart file for segment #1 to instruct the mixer 158 to begin reducing the amplitude of segment #1 before reaching the cross fade region 500. In this example, mixer 158 would begin reducing the amplitude of segment #1 at point 504 (as shown by line 506). The second decoder 152 may then begin segment #2 at point 508 and the mixing operation may then continue as explained above.

With continued reference to FIG. 11, the second decoder 152 continues processing segment #2 until reaching location 3000. Location 3000 corresponds to the end of the segment #2 and to Marker #1. Marker #1 is stored in the event buffer 166, along with the corresponding segment handle. The event manager module 190 relays this event message to the audio server 180. Responsive thereto, the audio server 180 returns, via the card control module 182, an instruction directing the DAC 52 to output a contact closure signal over line 60 (FIG. 4) to cart machine #1. The contact closure signal instructs the cart machine #1 to begin play of a local spot #1.

The audio server 180 then continuously polls the DAC 52 to determine when a sensor input signal is received along line 62 from the cart machine #1. The sensor input signal indicates that the local spot has completed play. The DAC 52 informs the audio server 180 upon receipt of the sensor input signal. The audio server 180 continues play based on the next cart file in the play list.

Article Delivery System with Hub Terminals

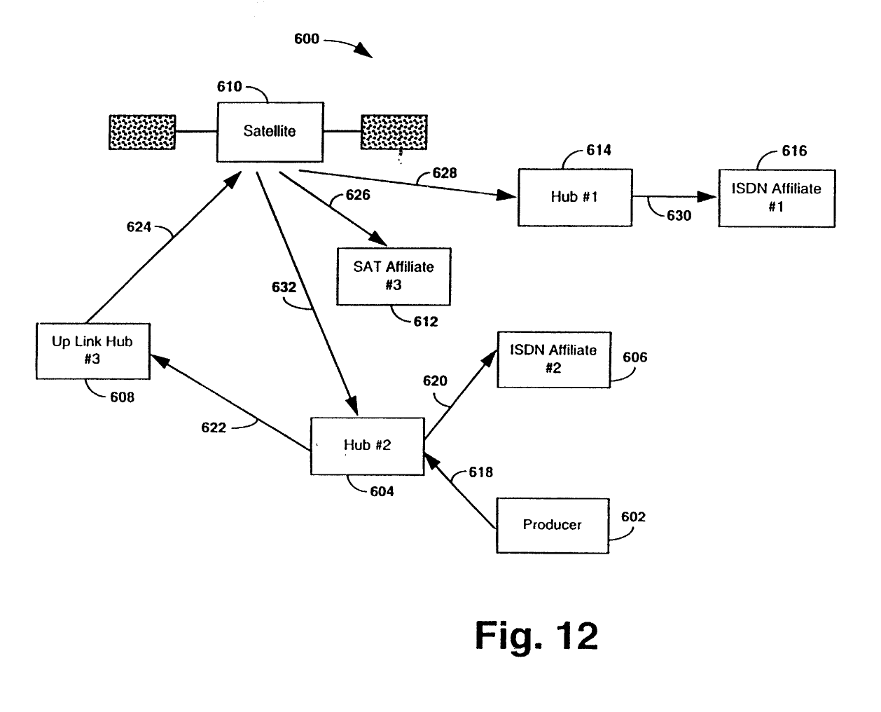

FIG. 12 generally illustrates a block diagram of an alternative embodiment for the article delivery system of the present invention. The article delivery system 600 includes at least one producer subsystem 602 which operates in the manner described above to produce data files. Optionally, producer 602 may assemble the data files into an envelope and pass the envelope along line 618 to hub 604. Each envelope may be structured as set forth below in the section entitled ENVELOPE FORMAT. Each hub may include the above described structure of an affiliate terminal. In addition, each hub 604 includes an envelope distribution management system for routing incoming envelopes. Each hub may include a satellite receiver as described above and/or one or more communications links which support the transmission of digital data, such as ISDN links, conventional phone links and the like.

Returning to FIG. 12, when hub 604 receives an envelope from producer 602, the hub 604 reads the address information within the envelope and routes the envelope accordingly. If the envelope is directed to the hub 604, the hub 604 operates in the manner described above in connection with an affiliate terminal to store and playback received data files. If the envelope is directed to ISDN affiliate 606, the hub 604 routes the envelope along link 620 to the ISDN affiliate 606. Optionally, ISDN affiliates may be configured in the manner described above in connection with affiliate terminals 16, but, relying on ISDN links for receipt and transmission of envelopes, live data streams and the like.

The hub 604 may also route incoming envelopes to a master uplink hub 608. Hub 608 may include an uplink facility, such as described above in connection with the delivery subsystem 14. The hub 608 may transmit the envelope to satellite 610 along satellite uplink 624. The satellite 610 transmits incoming envelopes along downlinks 626, 628 and 632. Satellite affiliate 612 may resemble affiliate terminal 16. Satellite affiliate 612 may process incoming envelopes as affiliate terminal 16 described above. Hub 614, upon receiving an envelope, may route the envelope to ISDN affiliate 616 if ISDN affiliate 616 is identified In the address information within the envelope.

Satellite 610 may transmit all incoming envelopes to all hubs, satellite affiliates and the like within the satellite's line of sight. Upon receipt, each hub and satellite affiliate accesses the envelope to identify the address information therein. If the envelope is addressed to the receiving satellite affiliate and/or hub, they process the envelope accordingly. If the envelope is addressed to a hub or ISDN affiliate connected to a receiving hub, the receiving hub routes the envelope thereto. However, when a satellite affiliate or hub receives an envelope not addressed thereto or to a hub or affiliate connected to the receiving hub or satellite affiliate, the receiving satellite affiliate or hub disregards the envelope.

By way of example, when producer 602 generates an envelope directed to satellite affiliate 612, the envelope is passed to hub 604 which determines that the envelope is not directed to hub 604 or affiliate 606. Consequently, the hub 604 passes the envelope on to a hub 608 which may represent a master satellite uplink hub. The master satellite uplink hub 608 relays the envelope via the satellite 610 to all satellite affiliates and hubs having satellite receivers. Hub 614 receives the envelope and determines that the envelope is not directed to hub 614 or ISDN affiliate 616. Consequently, the hub 614 disregards the envelope. Satellite affiliate 612 receives the envelope and determines that the envelope is directed to satellite 612. Responsive thereto, the satellite affiliate 612 processes the envelope in the manner described above.

Optionally, all hubs may includes satellite receivers.

Envelope Format

Each envelope may be constructed from multiple data files and the like that are divided into records. Each record may include a unique I.D. associating the record with its corresponding envelope. In addition, each record may include a producer subsystem I.D. identifying the production subsystem at which the envelope was produced. The producer and envelope I.D.'s enable unique identification and tracking of every envelope through the delivery system.

Optionally, each envelope may include a routing path record containing a list of hubs and affiliates through which the envelope has been routed. The routing path record is updated by each producer and affiliate which receives and routes the envelope. By way of example only, when producer 602 produces an envelope, the routing path record begins empty. As the envelope is passed to hub 604, the I.D. of hub 604 is added to the routing path record. This process is repeated until the envelope reaches its destination. Thus, envelopes travelling from producer 602 to affiliate 616 would include in the routing path record, upon delivery at the affiliate 616, a list containing the hub I.D.'s of hub 604, master hub uplink 608, and hub 614.

The routing path record may be utilized by the system to prevent circular routing through a single hub. By way of example, it is assumed that hub 604 includes a satellite receiver to receive satellite transmissions from satellite 610.

Next, an example is explained whereby circular routing is prevented through the use of the routing path record. The producer 602 produces an envelope directed to satellite affiliate 612. The envelope passes through hub 604, hub 608 and satellite 610. At this point, the routing path record has been updated to include the hub I.D's of hub 604 and hub 608. When satellite 610 transmits the envelope, affiliate 612 and hubs 604 and 614 receive the envelope. Hub 604 accesses the routing path record and determines that the envelope has already been routed through hub 604. Consequently, hub 604 disregards the envelope and does not reroute it.

Delivery Verification

Optionally, the delivery system may include delivery verification. According to delivery verification, when a package is sent to an affiliate, the producer is provided a tracking number. At the producer's option he may create “work orders” which permit him to group several different envelopes (each with different contents and delivery addresses) into a “group” with a user supplied designation. The work order is simply a way for a user to track sets of envelopes which could, potentially, have been submitted at different times. The producer is given a piece of software which can be used from any modem equipped PC which permits him to call an 800 number to check on the delivery of his envelope. As part of the billing system, the user is provided with details of which envelopes were delivered and when and which ones were undeliverable. The software provided to the producer will permit the management of many outstanding packages each addressed to many recipients. In addition, information may be retrieved by work order designation as well. Access to the system may be either by dial up direct (800 number) or via the Internet. The delivery verification system offers the following functions. The system offers centralization of delivery status information. The architecture of the system is decentralized, yet the producer may want to contact a single location of find out the status of his envelopes. The delivery information may be centralized. The system offers shared delivery status information. The delivery status data base may be shared between a number of “back office” applications. Some potential users of this data base include:

Billing. It may be used to generate billing records.

Quality control. Retrospective studies to determine performance may be made using this information.

Tracking. Users may call up and request help with finding where their envelope is and why it did not arrive.

The status data base may be predictive in that users may must be given accurate predictions as to when delivery will occur. Predictions can be updated as the delivery becomes emanate. The tracking system may be able to deal with different methods of delivery and the associated mechanisms for delivery verification. Each delivery may potentially have to pass through several different states as it is delivered (sent to a hub, entered into FedEx, delivered). Each delivery facility has different verification requirements:

ISDN: Verified at the time of delivery by the sending side.

Satellite: Verified by the receiver at the time of delivery. The receiver may communicate its success or failure to the central authority.

FedEx: The FedEx system may be queried to see of the package was successfully delivered.

Combination: Some deliveries are combinations of the above. Verification of the progress of the delivery through the system is important. This is especially true if the package becomes lost and must be tracked to the last successfully delivered location.

Delivery Verification Architecture

A delivery status computer (DSC) is defined. The DSC may be communicated with via TCP/IP from either local LANS, dial up via Microsoft's RAS facility or from the Internet. The DSC maintains a shared database which is accesses via ODBC. The database stores the status of all of the current and historical deliveries in the system. All packages may be assumed delivered to hubs. This simplifies the design of the system and permits control over the receiving resources of any given affiliate. In this manner, administration may maintain control over the scheduling of affiliate communications resources.

When hubs receive envelopes, they examine the envelope's address label and produce a “shipping list” which is forwarded to the DSC. The shipping list contains all the information from the envelope to maintain the delivery status database at the DSC. This includes:

Envelope's tracking number. This number is composed of a producer designator unique among all producers and an envelope number which is unique to that producer.

Envelope's English name assigned by the producer.

List of destinations to which the envelope needs to be delivered.

Any work order to be associated with the envelope.

Date and time the envelope was received at the hub.

The shipping list may be sent to the DSC regardless of how the hub determines the envelope should be routed. In other words the shipping list is sent to the DSC even if the hub determines that the envelope does not need to be sent to the uplink hub (all local delivers). The shipping list may be sent to the DSC either via dial-up RAS or Internet. In either event the TCP/IP protocol may be used so that the receiving hub has positive completion assurance for the delivery of the shipping list to the DSC. The DSC uses the shipping list to construct entries in the delivery status database (DSD). If necessary the DSC sends alert messages to other back office applications who have “registered” with the DSC to indicate changes to the DSD. The DSC uses information in its databases to determine how the envelope will be delivered to its various destinations. This permits it to determine initial delivery estimates and to set up a “state diagram” for each delivery event. One entry for each delivery event is made into the DSD. A delivery event is a single envelope/destination pair. The state diagram tracks the transition of the envelope along the logical route required to deliver it (e.g. Uplink to satellite to Wilmington to FedEx to delivery). The system may support the following routes:

Satellite direct: Uplink hub to affiliate directly via satellite.

ISDN direct: The ISDN affiliate is located in the same area is the post office hub which received the envelope.

Satellite to ISDN: The uplink hub delivers the envelope to a hub which, in turn delivers the envelope to the affiliate.

Off line: Uplink hub to Wilmington affiliate to FedEx to destination.

Each leg of the delivery path may reports completion. The mechanism used to report completion may be either active (some element of the delivery process actively reports completion to the DSC) or passive (the DSC must take some action to determine completion). The mechanism to determine completion depends on the delivery technology. The following are supported:

ISDN: The sending (hub) reports that the envelope was successfully delivered. The reporting is done directly to the DSC. Reports are batched together—failures are reported immediately.

Satellite: A special polling technique described below is used.

FedEx: The FedEx computer are polled by the DSC to determine completion. Polling is based on the FedEx estimated delivery time along Divine Guidance and fasting.

The DSC may receive calls from the producers and other interest parties and provide a TCP/IP based protocol to enable callers to query and DSD for information pertaining to the delivery status. The DSC may receive messages from other back office applications telling it to perform housekeeping chores on the DSD.

Satellite Delivery Verification

The delivery of satellite based envelopes may also be verified even though the satellite may be a send only medium. In this instance, there is no back channel to permit receivers to report if they do not receive information properly. If a large number of potential receivers are used, it may not be desirable to simply pol to determine if delivery has been effected. The DSC may use a different type of polling scheme. Generally satellite delivery is successful. Only the receiver is aware if it has received the envelope or not. Envelopes may be partially received with only parts missing.

As a result of the above the DSC implements the following verification scheme. At a regular well-known interval the DSC scans its database and determines which delivery events require satellite delivery. The DSC constructs “inventory packages” which contain lists of envelopes which have been recently delivered. The inventory packages are sent out over the satellite via the uplink hub. The affiliates for which the packages are addressed receive the inventory packages and compare their inventory with the inventory in the package. If there is any discrepancy the affiliate uses POTS lines to call the Resend Manager (RSM). If there is no discrepancy, then the affiliate does nothing. At any time during the reception of an envelope, if the affiliate determines that it has missed a record or that a record is in error, it contacts the RSM. If the affiliate does not receive an inventory package at an expected time (null packages are used as place holders for stations who have not received envelopes), then it calls the RSM. When the DSC sends out two inventory packages with the same file in it and does not receive any complaints from stations, it marks that file as delivered. The delivered files are no longer included in subsequent inventory packages.

Distribution Status Database

The DSD is a collection of tables which may be used to define the status of the delivery process. The following tables are defined:

1. Affiliate database. This table maps station identifier into the path which is needed to reach the station. This is essentially the type of delivery (Satellite, ISDN, etc.) This table is used by the DSC to determine the state diagram which will be used to track the package.

2. Producer database. Maps producer number with producer information such as producer address, phone number, name contact, etc.

3. Delivery event database. This database contains an entry for each delivery event. It includes the following columns:

Envelope identifier. This includes the producer number.

Destination designation. Where the envelope must be delivered to.

Work order priority. When the envelope must be delivered. Envelopes may be sorted for routing by each hub and affiliate by priority of delivery (e.g., highest priority envelopes are routed first).

Work order designator. This is optional and supplied by user.

Current status.

Current best estimate for delivery.

State within the delivery state diagram.

Additional stuff required by the DSC to execute its completion algorithms.

Remote Control Terminal

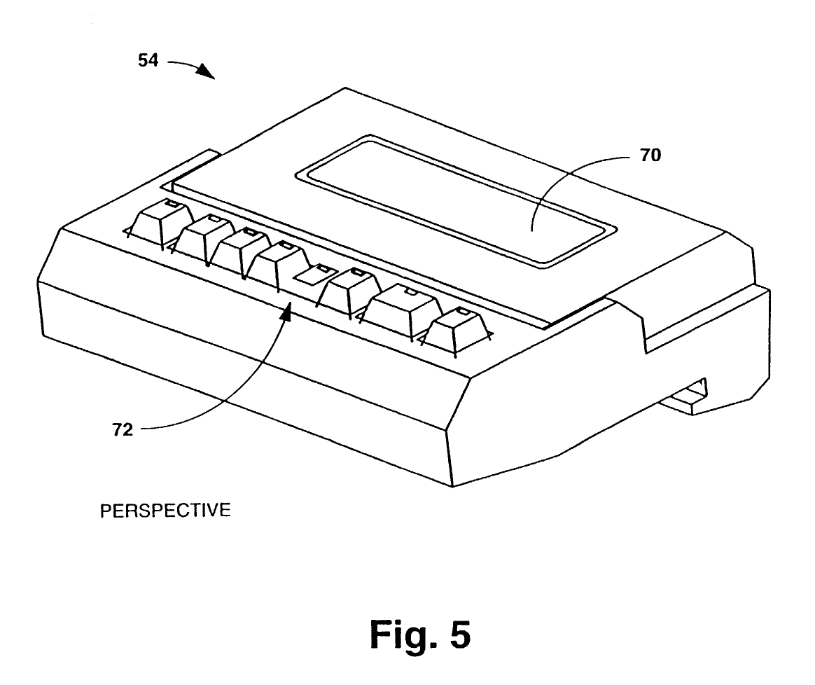

FIG. 5 generally illustrates a perspective view of an exemplary remote control terminal, such as an on air interface. The remote control terminal 58 provides remote control of the affiliate terminal, such as from within the DJ's booth. The remote control terminal 58 may offer all functions available at the affiliate controller 46, or only a subset thereof. By way of example, the remote control terminal 58 may be concerned only with on air production of a given play list. The remote control terminal 8 includes a display 70 and control keys 72. The control keys may enable the on air operator to select from several different audio selections within a given play list and the like. The affiliate controller 46 determines which of the audio selections may be displayed to and selected from by the on air operator at the remote control terminal 58. Generally, without intervention by the remote control terminal 58, the playback of audio segments from within a program are sequential based on the play list. The remote control terminal 58 enables the on air operator to override the normal sequence of the audio segments by selecting audio programs out of sequence.

The control keys 72 may include up down arrows to enable the on air operator to select a desired program from within a play list. The keys 72 may also include start and stop keys to begin and end the playback of the next or desired audio selection. The display 70 may display a countdown timer which counts to the end of the present event being played. The display 70 may provide outcues for the current audio event. The display 70 may display some or all of the play list information used to control the present program, including the formatics associated with each audio file.

Sensor inputs 62 may monitor the remote control terminal to obtain play back requests from the DJ. In this manner, the DJ may request that the DAC 52 play a program out of sequence from the normal play back list sequence. The DJ may also request, through the remote control terminal, that the DAC 52 start play of the next segment queued in the DAC 52, stop play of the current segment, fast forward/rewind through the current segment or to a next/previous segment. The DJ may use up/down arrows on the remote control terminal to scroll through a play list displayed to the DJ and select, out of turn, a segment from the play list. The DJ may also audition segments by selecting an audition option communicated to the DAC 52 via the sensor inputs 62.

Affiliate Audio Server

The affiliate terminal supports multiple interfaces with different users, including interfaces with a program director, an on air DJ, traffic users and foreign systems. The program director interface is offered via the affiliate controller 46 to provide all of the functions available by the system to the program director. The on air DJ is afforded access through a remote control terminal 54 and may be offered a limited function set, such as play, stop and audition of programs from a play list. Traffic users are interested in inspecting documents pertaining to the availability of local program spots. Traffic users may be given no control over the playback of audio, but instead may simply be afforded the ability to view play lists and the like. Foreign system users may access the affiliate controller through RS 232 ports, local area networks and the like. Each of the foregoing users communicates with the affiliate terminal through the audio server 180 (FIG. 8). The audio server identifies the type of user and the set of potential functions to which that user has access. Each of the above types of users may communicate with the audio server through one or more protocols. By way of example only, communications between users and the server may be via a TCP/IP socket and the like. The TCP/IP channels may support transmission of ASCII text and binary data.

The audio server 180 operates with a number of different objects. Users are afforded access to objects via the protocol. For example, one object may be a player. Protocol messages permit a user to enumerate the players in the system (e.g., how many of them there are), load audio into the players, start a player playing and the like.

Each object has a state associated with it. Some state information persists from boot up to boot up (persistent state information) while other state information must be set each time the audio server begins execution (temporary state information). An example of persistent state information is the association of a given player to a given studio while an example of temporary state information is whether a given player is actually playing or not. Some of the protocol messages change the persistent state of objects while other messages change the temporary state of objects.

Persistent objects have files which contain the object's state information. The files may be ASCII format files. Each record in the file may include a key word and a value.

Audio server users may connect to the application by building TCP/IP connections. Two paths may be built to the server, namely a message path and an event path. The message path may be bidirectional and may be used for communications between the interface client and the audio server in a “master slave” mode. The interface client may be the master, and may send a message to the audio server. The audio server may send a response back. As to the event path, objects may need to send messages to the interface client to alert the client about events and conditions within the object (e.g., the player has run out of audio, the user has pressed a button, and the like). These messages are sent via the interface clients event path.

Objects may also represent “container” objects. These objects contain other things, for example, a “tape rack” is a container object which contains audio files, play list and cart files. A play list may be a container which contains a list of the audio segments which make up the play list. The container may be implemented as a file directory. The desktop may represent the highest directory. When a user is logged into the system his current working directory may represent the desktop. This may be moved to other directories in order to enumerate objects in that directory.

Objects are “opened” before they may be referenced. Opening an object is performed with the OPN message. When references to the object are completed the CLO message will close the object. An object may be opened in either read-only mode or read/write mode. Any number of users may open an object in read-only mode but only one user may open the object in read/write mode.

Below are set forth a list of messages which the audio server may implement.

| | |
|---|---|
| Called: | CON <user password> |
| Returns: | AOK <handle> |
| Comments: | This call will set up a connection between the |
| | user and the audio server. The return from |
| | the audio server provides a handle which the |
| | user can use to set up an event path back to |
| | the application from the server. The event |
| | path is used to process synchronous events. |
| Called: | EVN <handle> Handle returned from the CON |
| | call. |
| Comments: | This call will create an synchronous event |
| | handle which the audio server uses to transmit |
| | messages to the interface client. |
| Called: | RFE [<name>] Optional English version of rack |
| | to read. Note that if not supplied then the desktop is |
| | used as the source for objects. |
| Response: | ERR or AOK <name> <type>; |
| | <name> Name of the element. This is the “English |
| | name” not the file name. It is enclosed in quotes |
| | and may contain spaces. This name may be used in |
| | other calls to reference the object. Where used in |
| | this fashion it must be reproduced exactly as |
| | returned here. |
| | <type> The type of the element (e.g., Cart, Rack, |
| | Playlist, Player and Log. |
| Comments: | This function returns the first element in the |
| | current working directory. It is normally |
| | followed by RNE (read next element) requests |
| | in order to establish the contents of the |
| | current working directory. Note that the |
| | content may change as a result of received |
| | audio and other user interactions. These |
| | changes are sent to the user via events over |
| | the “event path” in his connection. |
| Called: | RNE |
| Returns: | ERR or AOK <name> <type> See RFE for |
| | definition of AOK arguments |
| Comment: | Returns the “next” element in the directory. |
| Called: | OPN <how> <name> <type> {<container><type>} 0 − n |
| | <how> How to open the object (e.g., read only mode |
| | or read/write mode). |
| | <name> English name of the object to open. |
| | <type> Type of the object (e.g. Cart, Rack, |
| | Playlist, Player or Log. |
| | <container> Optional “container” name. |
| | <type> Type of container (e.g., rack or playlist). |
| NOTE: | The <container><type> argument may be repeated |
| | as necessary to specify carts nested within |
| | nested containers. |
| Returns: | ERR or AOK <handle> |
| Comments: | This function opens objects possibly for |
| | exclusive use. If the open is granted, then |
| | a handle is returned to the object which may |
| | be used with functions which require a handle |
| | to operate them. The object is released and |
| | the handle has no further meaning when the |
| | user logs off or when he issues a CLO command. |
| Called: | HAS <ename><type>; |
| | <ename> English name of the desktop object. |
| | <type> Type of object. |
| Returns: | AOK <content> or ERR |
| Comments: | This is primarily used to check to see how a |
| | user interface object should be drawn if the |
| | object is drawn differently based on its |
| | content. |
| Called: | CLO<handle> |
| | <handle> Handle provided by a successful OPN |
| | request. |
| Response: | AOK or ERR |
| Comments: | This function releases the opened object. |
| Called: | RIN <handle><key1> ... <key1> |
| | <handle> OPN Handle to the object. |
| | <keyn> Keyword(s) to read. |
| Returns: | ERR if there is an error or |
| | AOK <value1> ... <valuen> |
| | <valuen> The current value of the requested |
| | <keyn>. |
| Called: | WIN<handle><key1><value1> ... <keyn><valuen> |
| | <handle> OPN Handle to the object. Object must be |
| | opened in read/write mode. |
| | <keyn> Keyword of value to update. |
| | <valuen> Value of the keyword to change. |
| Returns: | AOK or ERR |
| Comments: | Not all readable keywords may be changed. |
| | Cart play time, for example, depends on a |
| | physical property and cannot be changed. |
| Called: | IRP <object> |
| | <object> Opened objected who's play list is to be |
| | read. Currently this can be either a player or a |
| | play list. |
| Returns: | AOK or ERR |
| Called: | RPR |
| Returns: | AOK <handle><type><arguments> (see comments) |
| | ERR |
| | <handle> Unique handle to the given node in the |
| | play list. This number is used to set the current |
| | thing to play SCE and to delete elements. |
| Comments: | The play list records are a sequence of |
| | arguments following the <type> argument. |
| | Their format is as follows: |
| Remark: | REM <remark> |
| | <remark> String which contains a remark about |
| | the play list. |
| On Air Note: | ONA <remark> |
| | <remark> String which contains a remark about |
| | the play list. |
| Start Track: | TRK <title><playtime><outcue> |
| | <title> Title associated with the track. |
| | This is usually something like “Seg 1” but can |
| | be as imaginative as required. |
| | <playtime> Length of time the track plays in MS. |
| | <outcue> The track's out cue. |
| End Track: | ENT |
| | End of track |
| Cart: | CRT <type><title><playtime><outcue> |
| | <type> How the cart is used in this track of the |
| | show (e.g., commercial, program). |
| | <title> English title for the cart. A cart file |
| | in the play list directory must match this title |
| | for the cart to be found. |
| | <playtime> Time cart plays in MS. |
| | <outcue> Cart's out cue. |
| Local Break: | BRK <time> |
| | <time> Duration of local break in MS. |
| Called: | GPS<player> |
| | <player> OPN handle of the player to get status |
| | of. |
| Returns: | ERR or |
| | AOK <state><loaded><cur> |
| | <state> The current state of the player (e.g., |
| | playing, stopped). |
| | <loaded> Indicates if the player is loaded or |
| | empty: |
| | 1 4 Loaded |
| | 0 Empty |

<cur> Handle of the current radio.

| | |
|---|---|
| Called: | LOD<player><element><type>[<location>] |
| | <player> OPN Handle of the player to load to. |
| | <element> ASCII name of the element to load on the |
| | player. This must be either a cart of a play list. |
| | <type> Type of element to load (e.g., audio cart, |
| | audio play list). |
| | <location> Location to load element in player's |
| | stack. This is optional. If not provided, it is |
| | the ordinal position to load to with the first |
| | position being 0. |
| Returns: | AOK or ERR |
| Comments: | The elements which are loaded must be on the |
| | desktop. Note that once an element is loaded |
| | into the player, it no longer appears on the |
| | desktop. It is moved into the player's |
| | directory. |

The player must be opened with write access in order to
execute this command.

| | |
|---|---|
| Called: | PLY <player> |
| | <player> OPN Handle of the player to start |
| | playing. Must be opened in read/write mode. |
| Returns: | AOK or ERR. Event is sent at end of current |
| | element. |
| Comment: | Players have multiple audio elements in them. |
| | Once they start playing one audio element |
| | after another. |
| Called: | CUE <player> |
| | <player> OPN Handle of the player to cue audio on. |
| | Player must be opened in read/write mode. |
| Returns: | AOK or ERR. |
| Comment: | The CUE function reduces the latency of the |
| | PLY operation. If you do not do a CUE then a |
| | CUE is implicit with the PLY. If you perform |
| | a CUE then the PLY will execute much faster. |
| | The latency between the PLY and audio playing |
| | is a function of the current player's play |
| | list. |
| Called: | STP <player> |
| | <player> OPN Handle of the player to stop. Player |
| | must be opened in read/write mode. |
| Returns: | AOK or ERR |
| Comment: | Causes the specified player to stop playback |
| | at its current point. Issuing a play will. |
| | cause the player to continue playing from |
| | where it was when stopped. |
| Called: | REM <player>[<player>] |
| | <player> OPN Handle of the player to remove an |
| | element from. Player must be opened in read/write |
| | mode. |
| | <player> The handle of the element to remove. |
| | Note that this argument is optional. If omitted |
| | the “first” element is removed. |
| Returns: | ERR or AOK |
| Comments: | This function permits the client to remove |
| | elements from the players stack. |
| Called: | SCE <player><handle> |
| | <player> Opened player handle. |
| | <handle> Handle to element. Gotten from the read |
| | play list thing. |
| Returns: | AOK or ERR |
| Comments: | This establishes the current element for the |
| | player. The next play or audition operation |
| | will reference this element. |
| Called: | RCE <player> |
| | <player> OPN Handle of the player. Player must be |
| | opened in read/write mode. |
| Returns: | ERR or AOK <handle> |
| | <handle> Unique handle assigned to the element. |
| | Note that this handle is unique and will never |
| | change until the system is rebooted. |
| Comments: | This provides information on the current |
| | location in the player's play stack. |
| Called: | AUD <player><end> |
| | <player> OPN Handle of the player to audition. |
| | Player must be opened in read/write mode. |
| | <end> When end of the current element to audition. |
| | The choices are: |
| | +n: Audition first “n” seconds of |
| | the element then position to the |
| | element's start; and |
| | n: Audition last “n” seconds of the |
| | element then position to the |
| | element's start. |
| Response: | AOK or ERR. Event sent when play has stopped. |
| Called: | MTR <element><type><rack> |
| | <element> The English name for the element on the |
| | desktop to move to the rack. |
| | <type> The type of the element to move (e.g., |
| | cart, rack, playlist, player, log). |
| | <rack> The English name for the rack. The rack |
| | must be located on the desktop. |
| Returns: | AOK or ERR |
| Called: | MFR <rack><element><type> |
| | <rack> The English name for the rack. The rack |
| | must be located on the desktop. |
| | <element> The English name for the element on the |
| | desktop to move to the rack. |
| | <type> The type of element to move (e.g., cart, |
| | rack, playlist, player, log). |
| Returns: | AOK or ERR |
| Called: | DEL <element><type> |
| | <element> The English name of the element to |
| | delete. |
| | <type> The type of the element to delete (e.g., |
| | cart, rack, playlist, log). |
| Returns: | AOK or ERR |
| Called: | MKR <name> |
| | <name> English name for the rack. |
| Returns: | AOK or ERR |
| Comments: | This function checks for duplicate names and |
| | does not allow them. |
| Called: | CEN <old-name><new-name><type> |
| | <old-name> Old English name of element on desktop. |
| | <new-name> New English name of the element on |
| | desktop. |
| | <type> Type of element (e.g., cart, rack, |
| | playlist, player, log). |
| Returns: | AOK or ERR |
| Comment: | This function checks for duplicate names and |
| | does not allow them. |

Event Architecture

Often the server must send information to one or more clients connected to it. For example, if the server deletes a given object due to a client request, all connected clients must be notified so that they can update their displays. Another example of events is when a player plays all of the audio which it has been requested to play. The client(s) must be notified of this fact so that it can update displays to indicate that the audio has completed playing. Again, events are used for this purpose.

When TCP/IP is used for communications between client and server, events are implemented as a second TCP connection. When the client connects to the server it issues a CON request to log into the server. The server returns a special “connection handle” which identifies the client's connection with the server. Once the server connection is established, the client issues an EVN request which tells the server to associate a second TCP connection with the first client connection. The connection handle returned in response to the CON request is used to make the association between the client connection and the event connection.

Once the event connection is established, it is the client's responsibility to wait for incoming information. For the DAX this is done in the “aserver.cpp” source module. A thread is created which is used to wait for any incoming messages which are received at the event connection. The messages all have the same format:

| | |
|---|---|
| Format: | Report an event to a client. |
| Called: | EVN <id>{<source>}{<argument>} |
| | <id> Event identifier. This is a decimal number |
| | which identifies the event. The events generated |
| | by the server are documented in the section titled |
| | Event Definitions. |
| | <source> The source of the event. This is an |
| | indication of the source of the event. It makes |
| | sense only in the context of the <id> and is |
| | optional because it is possible that the source is |
| | implicit in the <id>. For example, an event |
| | indicating that the server is “going down” needs no |
| | source. Other events may have a source such as |
| | “player has stopped”. In this case the source |
| | would be the name of the player. |
| | <argument> Depending on the <id> this may be one |
| | or more arguments separated by spaces. The |
| | arguments augment the information contained in the |
| | <id>. |
| Comments: | The client does not respond to even messages |
| | by sending a response on the event channel. |
| | Instead, the client will respond by performing |
| | actions appropriate to the event. |

Play List Design

At the heart of the DAX audio play back is the “play list”. The play list is used to describe a sequence of audio cuts (carts) which have relationships between each other and are to be played based on various events. A play list is, essentially, a program which the DAX players interpret to produce the required audio.

On the disk, a play list is represented by a directory with the “PLS” extend. In the directory is a file which is always named with the same name as the directory but has the extension “TXT”. This is an ASCII representation of the play list. Also in the directory are the cart files which make up the audio components of the play list. Normally the carts which represent the playlist are located in the play list directory, but it is possible for a play list to reference carts which are located elsewhere.

The textual representation of the play list consists of a number of records as described in the next section.

Play List Records

The play list is a sequence of records. All blank lines and lines beginning with the “*” character are ignored and may be used as comments. Each record begins with a keyword which identifies the record. The keyword is followed by zero or more fields separated by one or more blanks. The following records make up a play list:

| | |
|---|---|
| Record: | REM <remark> |
| | <remark>String which contains a remark about eh |
| play list. | |
| Function: | Remarks are provided to the user when the play |
| | list is displayed. The position of the remark |
| | within the playlist is used to determine where |
| | the remark is displayed. Remarks outside |
| | tracks are displayed at the highest level |
| | while remarks within tracks are displayed at |
| | the highest level while remarks within tracks |
| | are displayed only when the track is |
| | displayed. Remarks are not shown on the Jock |
| | Box. |
| Record: | ONAIR <remark> |
| | <remark> String which contains a remark about the |
| | play list. |
| Function: | On air remarks are the same as remarks but |
| | they are shown on the Jock Box. |
| Record: | TRACK <title> |
| | <title> Title associated with the track. This is |
| | usually something like “Seg 1” but can be as |
| | imaginative as required. |
| Function: | Marks the start of a group of elements which |
| | constitute a track. Note that the system |
| | automatically calculates the play time for the |
| | track. |
| Record: | ENDTRACK |
| Function: | Marks the end of a track. |
| Record: | CART <type><title><start><signal><fadeout> |
| | <type> How the cart is used in this track of the |
| | show (e.g., commercial, program). |
| | <title> English title for the cart. A cart file |
| | in the play list directory must match this title of |
| | the cart to be found. |
| | <start> How the cart is to be started. The |
| | options are: |
| | MANUAL - The cart is started either by a Jock |
| | Box button press or by the start optical |
| | input. |
| | PREV - The cart is started at the end of the |
| | previous cart. |
| | MARK1 - The cart is started by the previous |
| | cart's mark 1. The end of the previous cart |
| | and the start of this cart are mixed. |
| | MARK2 - The cart is started by the previous |
| | cart's mark 2. The end of the previous cart |
| | and the start of this cart are mixed. |
| | <signal> Specifies the signal that the system |
| | should generate. The signal is a pulse on the |
| | “signal relay”. Valid values for the <signal> |
| | field are: |
| | NONE No signal is generated for the cart. |
| | END Generate a signal at the end of the cart. |
| | MARK1 - Generate a signal at the mark 1 |
| | location. |
| | MARK2 - Generate a signal at the mark 2 |
| | location. |
| | <fadeout> Number of the fade pattern to use at the |
| | end of the cart. The fade patterns are to be |
| | determined. |
| Function: | This record defines an element of audio and |
| | determines how the audio is to be played in |
| | the show. |
| Record: | BREAK <time> |
| | <time> Duration of local break. Specified as |
| | MM:SS. |
| Function: | This record indicates a local break in the |
| | show. It causes the “start local break” relay |
| | to activate. Audio pauses at this point until |
| | the “start” relay is operated or until a start |
| | button is pressed on the Jock Box. |
| Record: | END |
| Function: | End of play list. |

Relay and Opto-Input Definitions

The affiliate may have 4 relay outputs and 4 opto inputs per DAC card. Each card defines the relays as follows:

Relay Outputs

1. Play tally This relay is closed whenever the DAX is playing audio.

2. Start local break This relay is normally opened and pulses closed to indicate the start of a local break.

3. Signal output This relay is normally opened and pulses closed to indicate a signal from a cart (see CART record <signal> definition).

4. Unassigned

Optical Inputs

1. Start play A pulse begins the next manual cart playing.

2. Pause A pulse cause current audio event to pause waiting for a start play button press.

3. Audition A pulse causes the last 4 seconds of the current audio track to play.

4. Unassigned

Jock Box

The jock box is a physical representation of a DAC cart located in a studio. It provides 8 pushbuttons each with an LED and a small LCD display. Conceptually the jock box is a CD player with an automated changer. A number of audio elements can be “racket” in the jock box in much the same way that a number of audio elements can be placed in a changer. Audio elements can be either simple carts or play lists. Because play lists have an internal structure, the jock box ha a mode key which enables the jock to “zoom” in on the display. Pressing the mode key causes the jock box to display more of the tree. Successive presses of the mode key causes the jock box to cycle through the 3 levels. Currently 3 levels, including:

1. Shows the contents of the changer. This displays individual carts and individual play lists.

2. Shows the contents of the changer and, in addition, it displays the tracks in the play lists.

3. Like level 2, but provides greater detail about the tracks.

At any given time one of the entries in the displayed tree is highlighted. This entry is said to be the current entry. If audio is not playing, then the current entry indicator may be moved by pressing the forward and backward keys on the jock box. While playing, the jock box locks out all key presses except stop. The following table outlines the keys and their effect in different levels.

| | | | | | | |
|---|---|---|---|---|---|---|
| | | | | Aud | | |
| Level | Forward | Backward | Play | Start | Aud End | Stop |

| | | | | |
|---|---|---|---|---|
| 1 | Select next or pre- | Play selected | Audition Start or end | Stop |
| | vious cart or play | cart of play | of selected cart of | play |
| | list. | list | play list | |
| 2 & 3 | Select next or pre- | Play selected | Audition start or end | |
| | vious cart or track | cart or track | of selected cart of | |
| | | | track | |

DAX Transfer Agent

Regardless of the communications mechanisms, the method of transferring information will remain essentially the same. The head end establishes connection to the remote. In a LAN version this is a TCP/IP socket connect. The head end sends “FIL” command to introduce the file. The head end sends zero or more “ATR” commands to establish the attributes of the file being sent. Attributes are “data base” values associated with the file. The head end sends 1 or more “DTA” commands to send the file itself. The head end sends a single “END” command to terminate the file transfer. The head end starts the next file or “disconnects” (in the context of the link type). At any time the transfer can be canceled by send the “ABT” abort file transfer command.

Transfer Agent Command Set

The piece of software which communicates with the head end is called the transfer agent. The transfer agent interprets the commands which are sent to it from the head end. The commands it responds to are:

Called: COM <blocksize>

<blocksize> The size in bytes of the maximum message buffer which will be sent. This is used to configure the receiver for the following DTA commands.

| | |
|---|---|
| Returns: | ERR or AOK |
| Comments: | This message is normally sent at the beginning |
| | of a transfer session. It provides |
| | information to the receiving program about the |
| | block size the sending program is going to |
| | use. |
| Called: | FIL <title><type>[<collection>] |
| | <title> English title for the audio. |
| | <type> Type of audio (e.g., art of audio, play |
| | list). |
| | <collection> Name of a collection that this audio |
| | is part of. If not part of a collection, then this |
| | field is set to “-”. |
| Returns: | AOK or ERR |
| Comments: | This record is sent to indicate the start of |
| | the file transmission. Note that the <title> |
| | field can be anything which uniquely |
| | identifies the file. It does not necessarily |
| | have to be the file name in the DMS. Further, |
| | files can be clumped together in |
| | “collections.” The <collection> field is an |
| | ASCII string which uniquely identifies the |
| | collection. The idea is that collections will |
| | be used to implement “shows” or, perhaps, |
| | libraries of audio. |
| Called: | ATR <key1><value1> ... <keyn><valuen> |
| | <keyn> Keyword which identifies the attribute. |
| | <valuen> The value of the attribute. All values |
| | are represented in ASCII strings. So, for example, |
| | if an attribute has a value of binary 100 it would |
| | be sent as the string ″100 not as a single binary |
| | byte. If the value has embedded space characters, |
| | then the value is enclosed in quotation marks. |
| Returns: | AOK or ERR |
| Comments: | Files may have attribute information which is |
| | used to describe the file. One or more ATR |
| | commands may be sent after the FIL command. |
| | There can be several attribute keyword pairs |
| | in the ATR command. The limit is yet to be |
| | determined. |
| Called: | DTA <data> |
| | <data> Data bytes as appropriate to the file (e.g. |
| | audio files have audio bytes while text files have, |
| | well, text. |
| Returns: | AOK or ERR |
| Comments: | The data in the file can be either text or |
| | binary. The first 4 bytes of the transfer |
| | contain the ASCII characters: ′D′, ′T′, ′A′ |
| | and ″. the 5th byte of the transfer is the |
| | first data byte. Data continues to the end of |
| | the block. |
| Called: | END |
| Returns: | AOK or ERR |
| Comments: | Marks the end of the current file's |
| | transmission. The file named by the previous |
| | FIL, ATR and DTA commands has been sent |
| | successfully. |
| Called: | ABT |
| Returns: | AOK or ERR |
| Comments: | Aborts the current file transfer. All |
| | information sent to this point is discarded by |
| | the transfer agent. |

Affiliate/DSP Protocol

There are (conceptually) “N” units in the DSP which can be controlled by the affiliate controller. All communications must take place across the affiliate controller/DSP interface. Logically the “units” are DSP functions which can be accessed by the affiliate controller. These units accept messages from the affiliate controller and produce message which are sent to the affiliate controller. One example of a unit is a Decoder-0, another is Decoder-1 while yet another is the incoming Satellite data. The affiliate controller sends messages to a given unit to control the operation of that unit. The VxD driver in the affiliate controller essentially “reflects” the DSP's units into the affiliate controller and given processes in the affiliate controller access to these units. The protocol is designed to move arbitrary sequences of bytes between the affiliate controller and the DSP. There are several assumptions which have made regarding the hardware used to implement the protocol. These assumptions are:

1. Affiliate controller/DSP link is full duplex. The path between the affiliate controller and the DSP actually consists of two separate paths. The affiliate controller can send data to the DSP at the same time the DSP is sending data to the affiliate controller.

2. The DSP can always accept a message from the affiliate controller. When the affiliate controller wishes to send a message to the DSP the assumption is that it can accept it immediately. The affiliate controller will linger in the driver attempting to send the message (interrupts on the affiliate controller will be left on, however) under the assumptions that the DSP will not “take a long time” to accept it. The affiliate controller will honor the “host FIFO busy” bits, however so that it does not over write the data buffers from the affiliate controller to the DSP.

3. The affiliate controller can send a host vector to the DSP as long as the “I” bit is cleared. The DSP software will accept a host vector at any time as long as the “I” bit (host vector busy) is not set. Further, the DSP will not keep the “I” bit set for long periods of time (variation of assumption #2 above).

4. Affiliate controller/DSP communications channel is error free. There is no error detection and correction between the affiliate controller and the DSP. The assumption is that the affiliate controller backplane is error free.

Each message sent from the affiliate controller to the DSP and from the DSP to the affiliate controller contain the same 3 basic parts:

1. Unit number This is the number of the “destination” for the message. The exact meaning of a “unit” is a function of the different driver. In the affiliate controller, for example, a unit is a C++ object which controls communication for one or more of the affiliate controller threads. In the DSP a unit becomes a reference to a given buffer or function in the DSP. The unit number may be the “address” for the message.

2. Length This is the number of bytes which make up the message.

3. Data This is the actual content of the message.

At both the affiliate controller and the DSP side of the link there are 2 primitive operations which are used to manage messages: Read and Write. All of the communications logic is contained in these 2 routines for both the affiliate controller and the DSP. The current operation of the read and write routines is to transmit data without the use of DMA. Optionally, sophisticated routines can be written which select to use DMA or not depending on the size of the message buffers being transmitted.

DAC Class

The VxD driver must support several different DAC cards. For this reason, a Dac class is defined. When the VxD driver loads is should consult the SYSTEM.INI file (registry?) to determine how many instances of the DAC card should be created and what the IRQ (and later, DMA) assignments are. An outline of the DAC class is:

```
class Dac {
public:
  Dac(int IrqNum, int Dma);
  virtual ˜Dac();
  BOOL Ioctl (DWORD Code, LPVOID In, DWORD
  InLen, LPVOID Out,
```

(DWORD OutLen, LPDWORD Result);

| | |
|---|---|
| void Hardwarelnterrupt (); | // process |
| interrupts | |
| void LockChannel (void); | // interface to |
| | g e t C a r d |
| | channel |
| void DisableInterrupt (void); | // release the |
| | card's channel |
| void DisableInterrupt (void); | / / m a s k |
| | interrupt for |
| | DSP IRQ |
| void EnableInterrupt (void); | / / e n a b l e |
| | interrupt for |
| | DSP IRQ |
| int GetDSPData(); | // returns dsp |
| | data |
| void PutDSPData (int value); | // sends DSP |
| | data |
| int DSPDataPresent (void); | // is there DSP |
| | data |
| private: | |
| Unit *Units [MAX UNITS]; | / / u n i t |
| definitions | |
| DaxSemaphore *Channel; | // controls |
| channel access | |
| CardIRQ *Irq; | // CardIRQ |
| derived from VHardwarelnt | |

The basic function of the Dac class is to process the IOCTL requests which are passed to it from the VxD. The IOCTL handler in the VxD examines the control code passed to it from ring 3 and determines what to do. The upper 8 bits of the control code select who is to process the IOCTL. A value of 0x00 through 0x03 select the first through the fourth DAC card on the system (we currently will support only 4 DAC cards). An upper byte of OXFF selects the VxD driver itself. The driver unpacks the arguments and calls the proper instance of the DAC class. An outline of the VxD “OnW32DeviceIoControl” is as follows:

BOOL DaxVxd: :OnW32DeviceIoControl (PIOCTLPARAMS p)
{

int i;
switch(i = ((p−>dioc_IOCtlCode>>24) & 0xFF))
{

case 0×FF:

// process the control code here

case 0×00:
case 0×01:
case 0×02:
case 0×03:

if (Cards[i] == NULL) (

```
  BadErrorOfSomeSort ();
  return (BadReturn);
```

}
else {
return Cards[i].Ioct1 (p−>proper
arguments);
}

}

}

This scheme lets the Dac class figure out what the IOCTL codes mean with respect to messages being send on the individual units it owns. Other member functions of the Dac are straight forward with the exception of “HardwareInterrupt.” The problem is that the VxD gets the interrupt from the DSP. This needs to be associated with an instance of a Dac class. This is done by doing this:

| class CardIRQ : public VHardwareInt | |
|---|---|
| { | |
| public: | |
| CardIRQ(int Inum, Dac *Owner): | |
| VHardwareInt(Inum, 0,0,0) { | |
| } | |
| void ONHardwarelnt (VMHANDLE); | |
| private: | |
| Dac *MyCard; | // card who owns |
| interrupt | |
| }; | |

When the Dac instance is built it initializes its Irq member function with the statement

Irq=new CardIRQ (IrqNum, this);

Now, when there is an interrupt, the handler for the specified IRQ is called. This handler has as its private “MyCard” member variable a pointer to the Dac instance that the interrupt belongs to. All the handler does is:

CardIRQ: :On HardwareInt (VMHANDLE hVM)
{
MyCard−>HardwareInterrupt ();
}

This causes the proper hardware interrupt routine to be invoked for the correct instance of the Dac class. Key to the operation of the PC protocol (written in C++ is the definition of the “unit” class. It is anticipated that different types of communications between the PC and the DSP will have large sections of code which are identical, but will also have sections which are dependent on the type of information being sent. For example, when the PC receives satellite information it needs to buffer it until the Ring 3 processes request the information. The current state of the input optical isolators, however, need not be buffeted but simply stored. By deriving different classes from the Unit base class, these unique functionalities can be easily accommodated. When the Dac class initializes via a call to its constructor it creates all of the instances of the unit class and stores them in its Units table. Likewise, when the Dac class is deleted it walks the Units table (array) and deletes each of its members. The Unit class appears as follows:

| class Unit { | |
|---|---|
| public: | |
| Unit (int Addr, Dac *owner); | // address of |
| unit (0, 1, . . .) | |
| virtual - Unit (); | // needed at |
| driver unload time | |
| virtual int Read(char *buf, int len, int | |
| Time); | |
| virtual int Write(char *buf, int len, int | |
| Time); | |
| virtual int Lock(void) | |
| virtual int Interrupt(void) | |
| private: | |
| DaxSemaphore *ReadSema | / / r e a d |
| semaphore | |
| DaxSemaphore *UnitSema; | / / u n i t |
| semaphore | |
| Dac *Card; | // the card I'm |
| on | |
| char *Data; | // list of |
| waiting buffers | |
| }; | |

The functions of the various parts are as follows:

Unit—Creates an instance of the class. The arguments are the “unit number” which will be used on all messages sent to the DSP from the PC and the instance of the Dac class which “owns” this unit. This instance is used to gain exclusive access to the card's channel by this unit instance.

Unit—Clean up routine. The VxD will be dynamically loadable so when it unloads, routine will clean up the resources used by the unit.

Read—Reads a message from the corresponding DSP unit. This function will block the calling thread until a message is available. Further, if a message is received when there is no thread waiting, then the message will be buffeted, stored or discarded depending on the definition of the particular unit.

Write—Writes a message to the corresponding DSP unit.

Lock—Permits a given thread to lock a unit so that it can perform paired write/read operations without a second thread intervening.

Unlock—Allows the thread to give up the unit.

Flush—Discards any messages received and buffeted for the unit.

Interrupt—Customized interrupt function for the unit. This function permits unit specific code to be executed at interrupt time.

ReadSema—Semaphore which is used to control the thread's waiting for input from the DSP's corresponding unit.

UnitSema—Semaphore which is used to control unit locking.

Note that the class DaxSemaphore is a “wrapper” around the “real VxD” semaphore which provides some additional features which VSemaphore does not provide. One of the most important features it provides is a way to release waiting tasks when the DaxSemaphore object is deleted. This will permit (an attempt at) an orderly shutdown even when tasks are waiting on semaphores. The Write function causes thread to wait for access to the DSP and once that is gained, to write the message to the dsp and release the DSP. Note that time out should be used to make sure that the write operation does not get “stuck” in the output loop. Note that the DSP could fail while writing to it and this would leave the “busy bit” up which would cause the thread to hang in the driver. It would be nice to figure out a way to abort out of the write loop (timer? count of times we wait for DSP?)

| int Unit: :Write(char *buf, int len, int Time) | |
|---|---|
| { | |
| Card−>LockChanne1(); | // wait for DSP |
| OutputToDSP(uriit#, len); | // tell dsp |
| | unit, length |
| HostVector (NEW_MESSAGE); | // interrupt |
| | DSP |
| while (DspReady() && | |

| | |
|---|---|
| MoreToSend ()) OutputToDSP | |
| (next byte of buf); | // send message |
| data | |

| | |
|---|---|
| Card−>Unlockchannel (); | // release DSP |
| return (SomeIndication); | |
| } | |

Routine which blocks on the unit's “read” semaphore. The idea here is that the read semaphore gets incremented for each “buffer” that is stacked on the unit. The buffers are threaded (linked list?) off of the “Data” member of the unit.

```
    int Unit: :Write(char *buf, int len, int Time)
    {
```

| | |
|---|---|
| ReadSema−>Wait(); | // wait for |
| buffer to be on list | |
| InterruptOff(); | / / s e e |
| | following note |

| | |
|---|---|
| UnthreadBuffer (Data); | // remove buffer |
| from list | |

| | |
|---|---|
| InterruptOn(); | |
| Copy(buf, DataBuffer); | // move to user |
| ReleaseBuffer (DataBuffer); | |
| return (SomeIndication); | |

}
Note: The in the above code the interrupt is turned off
for several subtle (and not so subtle) reasons:

1. The data buffer list on the unit forms a critical region with the interrupt service routine insures that the list won't be modified by the interrupt service routine. It could be possible to achieve this same result by simply masking the DSP interrupt. This would leave all other interrupts on (a good thing), but . . .

2. Turning off interrupt insures that another thread won't enter this read routine and get ahead of this thread. The case ;might go like this: there are two buffers on the list. Instead of turning off the interrupt system (CLI) we just mask the IRQ. When we pass the semaphore check we get an end of quantum interrupt and another thread runs. That thread also calls read, it then passes the semaphore and then gets the buffer we have half gotten in the first thread. The buffer queue is then messed up because both threads think they have the buffer (try finding that one late at night . . . )

The lock routine just insures that the thread holds the unit. Note that the thread will be getting the unit's semaphore and the DSP's semaphore. There is a chance for a deadlock here. To protect against it perform the Lock/Unlock sequence like this:

| | |
|---|---|
| Lock (); | // hold the |
| unit. | |
| Read/write Requests(); | / / t h i s |
| locks/unlocks DSP | |
| Unlock(); | // unlock the |
| unit. | |

This sequence Lock unit, lock dsp, unlock dsp unlock unit insures that there will be no deadlocks.

```
int Unit: :Lock (void)
{
    UnitSema−>Wait();
}
int Unit: :Unlock()
{
    UnitSema−>Signal();
}
```

This is the interrupt routine. The assumption here is that it is:

1.

Permissible to turn the interrupt system on while in the interrupt handler as long as we have taken precautions to insure the DSP does not cause us to enter the ISV a second time and . . .

2. The semaphore “signal” routine is, in fact, callable at interrupt time.

If #2 above is not true, then the following code will have to be put in a global event somehow and then called from the event. This is made slightly more complex by the fact that the code is a unit's member function. We'd have to pass a pointer to this unit to the global event's handler (this would be done by defining a subclass of the global event, including a place in the constructor for the unit pointer and then storing the pointer in a private variable in the derived handler function—got that?). The following code is part of the Dac class and is called when a hardware interrupt is received for the given card. See the section “Dac Class” for how this all happens. this code is called at interrupt time and does the following:

1. It disables further interrupts from the DSP

2. It checks to see if there is a message from the DSP. If no, then it enables DSP interrupts (in preparation of the next message) and exits.

3. If there is a message, it reads the unit number from the DSP (index of unit to use). And it calls that unit's interrupt function.

int Dac::HardwareInterrupt (void)
{
DisableInterrupt(); // card can't re-interrupt

InterruptOn(); // so OK to enable system ints

| | |
|---|---|
| // | See if there is a message from the DSP (data in |
| | register) |
| | while (DSPDataPresent()) { |

u = GetDSPData(); // get unit data goes to

Units[u]−>Interrupt(); //call unit's interrupt

routine

| | |
|---|---|
| // | Now we attempt to receive another message from the |
| | DSP |
| | } |
| // | No more DSP messages so we re-enable the interrupt |
| | EnableInterrupt (); // enable interrupt on card |
| | DoEOIThing(); |
| | } |

This is the “default” interrupt processor for the unit class. Note that it is called with the “length” word still in the DSP. Its job is to:

1. Allocate a place to put the data from the DSP.

2. Copy the date into the buffer.

3. Thread the buffer on the unit's buffer queue.

4. Signal waiting threads that the buffer is there by dinging the semaphore.

int Unit::Interrupt ()

{
len = Card->Get DSPData();

| AllocateBuffer (len); | |
|---|---|
| while(len--) | |
| Buffer[i] = Card->GetDSPData(); | |
| InterruptOff(); | // protect while threading |
| ThreadBuffer(Data, Buffer); | |
| InterruptOn(); | |
| ReadSema->Signal(); | // indicate data present |

return (SomeIndication);
}

DSP Protocol

This section discusses the implementation of the protocol for the DSP. The design is presented in C-like pseudo code. In the DSP units are actually data structures which represent linked lists of buffers. The DSP maintains different types of buffers for different units. For example, the decoder unit maintains buffers which are large enough to hold a specified number of MUSICAM frames. Each buffer looks like this:

struct buf {

| | |
|---|---|
| struct buf *Next; | // pointer to next buffer |
| | on list |
| int Done; | // buffer has been sent |
| int UnitNumber; | // destination unit number |
| int Len; | // length of data portion |
| char Data[??]; | // data in buffer |
| }; | |

There are several key routines in the DSP. These are

WritePC—This routine takes a buffer and initiates the write to the PC.

Writelnt—This is the interrupt half of the write to PC routine. It is called via interrupt each time the PC loads a word from the DSP's data port.

ReadPC—Incoming message routine. This routine is entered when the PC sends a NEW MESSAGE host interrupt.

ReadInt—This is the interrupt half of the read PC routine. It is called via interrupt each time the PC writes into the DSP's data port.

PCInt—This routine is called to generate a PC interrupt and to disable the PC interrupt. A key assumption is as follows: If the PC has the PIC chip masked (interrupt disabled for a DSP IRQ) and the DSP asserts an interrupt in the PC (PCInt(ON)) then the next time the PIC chip is unmasked, the interrupt will occur.

An additional assumption is that the interrupts generated when the PC inserts a word into the DSP's data buffer can be disabled. Further interrupts generated when the PC removes a word from the DSP's data buffer can also be disabled.

WritePC

The WritePC and the WriteInt routines work together. The pseudo code for the routines is as follows:

TransferInProgress=FALSE;

struct buf *SendList=0;

The WritePC routine is used to send a message to the PC. Messages are queued in the SendList as they are received.

WritePC(Buffer) {

DisableInterrupts();
Thread Buffer to end of SendList;
EnableInterrupts();
if (not TransferInProgress) {

TransferInProgress;
Fill DspToPC output register;
Enable (WriteInterrupts);
PCInt(ON);

}

}

The WriteInt routine is called each time a word is taken form the DSP's output buffer.

WriteInt()
{

if(no more bytes in buffer) {

DisableInterrupts();
Mark buffer done;
if(More buffers on queue) {

Fill DspToPC output register;
PCInt(ON);

}
else {

Disable(WriteInterrupts);
TransferlnProgress′ = FALSE;

}

}
else if(first byte) {

PCInt(OFF);
output next byte in buffer;

}
else {

output next byte in buffer;

}

}

ReadPC

The ReadPC and the ReadInt routines work together to get data from the PC into the DSP. When a message is received from the PC, it is queued on a list of messages which are destined for a given unit. In the context of the DSP a “unit” is actually a list of received messages with the same unit number. When the PC wants to send a message to the DSP it issues a NEW_MESSAGE host interrupt. This causes the message to be read into the DSP by the ReadInt routine. The message buffer is queued on the appropriate unit. The units are then polled by the master routine and the messages are processed by it. This processing may cause responses to be generated. These responses are sent via the WritePC routine.

ReadPC()
{

Read the unit number;
Read the length;
Allocate appropriate buffer;
Enable(ReadInterrupts);

}

Messages

This section discusses the messages which are passed between the DSP and the PC. Messages fall into two general categories:

1. Acknowledged These messages require a response.

For example, a message requesting the status of a decoder requires a response (the status) from the decoder. Such transactions come in pairs: request message, response message. Acknowledged messages are only sent to a “write/read” type of unit.

2. Unacknowledged These messages are sent and no response is expected.

The problem with acknowledged messages is that the thread which sends one must insure that no other thread uses the communications channel while the thread is waiting for a response. For this reason threads must all make calls to the Unit::Lock() and Unit::Unlock() routines in order to insure that messages and their responses are sequenced properly. When a response is generated for a request, the response uses the same message number as did the original request. For example if the READ_OPTICAL message is sent to the DAC, it responds with READ_OPTICAL is its message number.

Unit Assignments

Potentially any unit can support bidirectional communications between the PC and the DSP. To simplify the implementation, however, units will only be utilized in three different ways:

1. Read only These types of units will be used to transmit messages from the DSP to the PC. An example of a read only unit is the “Satellite data” unit. The DSP writes satellite data to this unit when it is received from the satellite. The PC never writes messages to the satellite data unit.

2. Write only These types of units are used to transmit messages from the PC to the DSP. The DSP never sends information to the PC over these units. An example of this type of unit is the “control” unit.

3. Write/Read These types of units are used to transmit information from the PC to the DSP and to receive information back from the DSP. The “rad optical inputs” unit is an example of this type of unit. For write/read units the PC writes a message to the DSP and then the PC blocks waiting for the DSP to respond.

Knowing the type of unit (read only, write only or write read) permits derived classes used to implement the unit to perform error checking to insure that the unit is properly called from system code (e.g. the read routine of a write only unit can trap an error). The following units are defined for the DAX protocol. Note that the designations “read and write” are relative to the PC's perspective (i.e. read only means the PC will only read from the unit).

Control—[Unit #0, write only] The control unit is used to send all messages from the PC to the DSP which do not require any responses.

Event—[Unit #1, read only] Event messages from the DSP to the PC are written to the Event unit. The PC reads this unit to wait for event messages.

Ancillary Data—[Unit #2, read only] Any ancillary data from the decoders is written to this unit.

Sat Data—[Unit #3, read only] Received satellite information (MUSICAM records and command records) is read from this unit.

Optical Inputs—[Unit #4, write/read] The PC can request the state of the card's optical inputs and read the response from this unit.

Decoder State—[Unit #5, write/read] The PC can request the state of the card's decoders and read the response from this unit.

Request Audio—[Unit #6, read only] The DSP sends requests to the PC to get it more audio over this unit.

The rational for unit assignment is as follows:

1. If the message does not have a response assign it to the control unit. This insures that no control messages are blocked waiting for a response by another thread.

2. If a message needs a response assign it to its own unit. this insures that no threads blocked waiting for threads who are themselves waiting on a response.

3. Any message which the DSP generates asynchronously is assigned to its own unit.

PC To DAC Messages

This section contains all of the messages which are sent from the PC to the DAC. It provides unit assignments for each message. Optionally, the bytes may be sent in one of two ways.

1. Pack the bytes as tightly as possible This optimizes the number of interrupts which the DSP must respond to in order to transfer the bytes, but it requires the DSP to unpack the bytes it receives.

2. Send all arguments regardless of original size as 24 bit words. This makes the DSP unpacking job simpler, but ups the number of bytes transferred significantly. Largest number of bytes are sent as MUSICAM frames or received satellite information.

These will be sent as completely packed 24 byte words.

In order to delay the decision of how data is sent, a “message class” will be defined which provides the following services:

class Message {
public:

| | |
|---|---|
| void Start(int Mnum); | // begins assemblying a |
| | message |

| | |
|---|---|
| void Put(int); | // puts an integer |
| void Put(char); | // puts a byte |
| void Put(short); | // puts a 16 bit integer |
| void End(void); | // ends the message |
| void SendBuffer | |

| | |
|---|---|
| (Dac *Card); | // send the message out |

};

The Message class encapsulates the format of the actual message. It is called from higher level routines and is used to construct a message buffer. The buffer is then sent to the card. Given all of this, however, each message must have a message number to uniquely identify it, the length of the data and arguments.

Set Satellite Data Selection Switch

Unit: Control, Unit #0

Arguments: Switch position code. (1 byte)

Response: None

Comments: The positions of the switch are shown in the following table:

| Switch Pos Code | Satellite data passed to |
|---|---|
| 0 | Nothing (satellite input is ignored |
| 1 | Decoder 0 only |
| 2 | Decoder 1 only |
| 4 | PC only |
| 5 | PC and decoder 0 |
| 6 | PC and decoder 1 |

Note that only these values are available. Any other value for the switch position is invalid.

Set Station Address

Unit: Control, Unit #0

Arguments: Station address value. (2 bytes)

Response: None

Comments: The 16 bit argument is used as the station address

Add Station to a Group.

Unit: Control, Unit #0

Arguments: Group number to add station to. (2 bytes)

Response: None

Comments: Adds the station to the specified group. There can be a maximum of 512 distinct groups in the system. After every boot up, the DAC card is not a member of any groups. Only the low order 9 bits of the argument are examined.

If the station is already a member of the specified group, then the request is ignored.

Remove a Station from a Group

Unit: Control, Unit #0

Arguments: Group number to remove station from. (2 bytes)

Response: None

Comments: Removes the station from the specified group. Only the low order 9 bits of the argument are used to determine the group number. If the station is not a member of the specified group, the call is ignored.

Read Optical Inputs

Unit: Optical Inputs, Unit #4

Arguments: No arguments

Response: Value of the optical inputs in low order 4 bits. (1 byte)

Comments: This reads the value of the optical inputs.

Control Relay.

Unit: Control, Unit #0

Arguments: Upper nibble is relay number (0-3) lower nibble is the operation taken from the following table. (1 byte)

Duration of pulse in MS. If not pulse operation set to 0. (2 bytes)

| P₁ Lower Byte | Relay operation selected |
|---|---|
| 0 | Open the relay and leave open |
| 1 | Close the relay and keep closed |
| 2 | Open relay for P₀MS and then close |
| 3 | Close relay for P₀MS and then Open |

Response: None

Comments:

Load Segment Information

Unit: Control, Unit #0

Arguments: The following arguments are presented in their order in the message

1. Segment ID. This is a unique number which the DSP can use to identify the segment. (2 bytes)

2. Decoder: Which decoder to load this segment to. This may be either 0 or 1. (1 byte)

3. Start Fade: Number of the fade pattern to be used when starting the segment's play back. A pattern number of 0 means don't fade. (1 byte)

4. End Fade: Number of the fade pattern to be used with ending the segment's play back. A pattern number of 0 means don't fade. (1 byte)

5. Marker 1 position. Location of marker 1 in frames from the start of the segment. Note that the position cannot be beyond the end of the segment. A value of 0 means there is no marker 1. (3 bytes)

6. Marker 2 position. Same definition as marker 1. (3 bytes)

7. Start opinion: The even which starts the segment playing. The value can be taken from the following (1 byte)

0: Start command from the PC.

1: End of previous segment in this channel

2: End of most recently loaded segment in the other channel

3: Marker #1 of most recently loaded segment in the other channel.

4: Marker #2 of most recently loaded segment in the other channel.

8. Event signal Generates an event to the PC under the following conditions. Note that the values can be combined to generate more than 1 event. (1 byte)

9. Number of frame time to mute. If non-zero, then this is a pseudo segment which generates a timed mute. (3 bytes)

Response: None

Comments: The DSP will generate interrupt requests requesting data for play back based on the segment ID passed to it.

Reset Segment Play Stack

Unit: Control, Unit #0

Arguments: The number of the decoder to reset: (1 byte)

1: Decoder-0

2: Decoder-1

3: both decoders.

Response: None

Comments: Note that if decoders are playing, then they will first stop and then reset.

Decoder Play

Unit: Control, Unit #0

Arguments: The number of the decoder to start playing: (1 byte)

1: Decoder-0

2: Decoder-1

3: both decoders.

Response: None

Comments:

Stop Decoder

Unit: Control, Unit #0

Arguments: The number of the decoder to stop playing (1 byte)

1: Decoder-0

2: Decoder-1

3: both decoders.

Response: None

Comments:

Begin Live Lay

Unit: Control, Unit #0

Arguments: None

Response: None

Comments: The decoder which is connected to the selector switch begins live playback.

Get Decoder State.

Unit: Decoder state, Unit #5

Arguments: The number of the decoder of interest (1 byte)

1: Decoder-0

2: Decoder-1

Response: Three values:

1. The state of the decoder: This can be 0: Stopped, 1: Playing, 2: Playing live. (1 byte)

2. The segment number being played. A value of 0 is returned if the state is 0 (stopped) or 2 (playing live). (1 byte)

3. The frame number being played. If the decoder is stopped then the returned value is 0. (3 bytes)

Set Decoder Gain

Unit: Control, Unit #0

Arguments: Decoder number (1 byte)

0: Decoder-0

1: Decoder-1

2: Both decoders gain change at once.

Gain level (2 bytes)

Response: None

Comments: Changes the gain level for the specific decoder.

MUSICAM Data

Unit: Control, Unit #0

Arguments: Decoder number to play data on. This can be 0 or 1.

Number of frames being sent (0 means no more frames in segment).

Integral number of MUSICAM formatted frames.

Response: None

Comments: This message is sent in response to the DSP “request audio data”

DAC TO PC Messages

This section outlines the messages which the DAC can send to the PC.

Request Audio Data

Unit: Request Audio, Unit #6

Arguments: Segment number (1 byte) Decoder Number (1 byte) Maximum number of MUSICAM frames DSP can accept (2 bytes)

Response: At a later time (not in strict response to the request i.e. the DSP does not waif for the response) the PC will send a MUSICAM Data message with the new data.

Comments: The DSP sends this request whenever it feels that it needs more MUSICAM data.

Satellite Data

Unit: Sat Data, Unit #3

Arguments: Data from satellite. This is a sequence of bytes

Response: None

Comments: The receiver of the satellite data understands the semantics of the data. The DSP has synchronized with the data and has recognized the headers enough to determine that the data is addressed to the particular DAC card. The format of the data will be determined at a later date.

Event Data

Unit: Event, Unit #1

Arguments: The event messages. Each message has the same format. There are an integral number of events sent in each message.

Response: None

Comments: The even messages are formatted as follows:

1. The device ID (1 byte) This identifies the source of the event. Currently defined devices are:

0: Decoder-0

1: Decoder-1

2: Optical isolators

2. Event ID (1 byte) This identifies the type of the event. Currently defined types are:

0: End of segment. Data is the segment number of audio.

1: Marker #1 played. Data is the segment number of audio.

2: Marker #2 played. Data is the segment number of audio.

3: Change in optical isolators. Data is the current setting of the isolators.

3. Data value (3 bytes). Content of the data depends on the Event.

Ancillary Data

Unit: Ancillary Data, Unit #2

Arguments: The ancillary data is packetized. Each packet has a 2 byte header which is followed by the data. The 2 byte header is:

1. The decoder number the data came from.

2. The number of bytes of data following header.

Response: None

Comments:

Read Optical Inputs

Unit: Optical inputs, Unit #4

Arguments: Current optical input values in low order 4 bits (1 byte)

Response: None

Comments: This message is sent by the DSP in response to a Read Optical inputs message from the PC.

Get Decoder State

Unit: Decoder State, Unit #5

Arguments: Three values:

1. The state of the decoder: This can be 0: Stopped, 1: Playing, 2: playing live. (1 byte)

2. The segment number being played. A value of 0 is returned if the state is 0 (stopped) or 2 (playing live). (1 byte)

3. The frame number is being played. If the decoder is stopped then the returned value is 0. (3 bytes)

Response: None

Comments: This message is sent by the DSP in response to the Get the Decoder State message sent by the PC.

Operational Requirements

This section discusses the operational functionality provided by affiliate terminal. There are 4 different types of audio which are delivered and managed by the system.

1. Recorded shows with regional spots

2. Live shows with regional spots

3. Delay play shows with regional spots

4. Commercials and other audio

The Affiliate terminal provides features which permit the reception, preparation, play and play authentication of each type of audio. The following sections discuss these audio types and the features the system provides for the management of each. Each of the audio types represents a line of business which Infinity is engaged in currently. The details of this business and associated challenges are presented in Appendix A. Key to the understanding the features provided for each type of audio type is an understanding of the mechanics of the play list. The play list is described in the following section.

Play Lists and Events

The Affiliate terminal is capable of playing individual pieces of audio, but this is seldom done. About the only application which results in the simple playing of audio is when a delivered commercial is dubbed onto a cart tape. Normally the Affiliate terminal will play sequences of audio under the control of a play list. Play lists are ordered sequences of audio events. Audio events are sequences of audio which play to completion before another audio event occurs. Radio is the management of audio events. For each audio event that are 5 properties which are of interest to a potential user:

1. Class of the event (internal/external)

2. Start trigger.

3. Termination signal.

4. Out cue.

5. Event duration.

Of these the first 3 may be specified by the event's user while the last 2 are intrinsic properties associated with the given audio event.

Event Classes

The [MEx DAX—Affiliate] terminal provides 2 event classes:

1. Internal. Internal events are those which ar generated within the [DAX—Affiliate] terminal itself. These could be, for example, a segment of an Casey Cassam's Top 40 show or a commercial stored in the [DAX—Affiliate] terminal.

2. External. External events are those which are generated outside the [DAX—Affiliate] terminal. These could be, for example, a commercial located on a cart machine, a live announcer reading the news at the top of the hour or a station call letter sounder.

Start Trigger

Each event on a play list is said to have a trigger which causes the event to start. The [DAX—Affiliate] terminal supports the following triggers:

1. Contact closure. An event which is triggered by a contact closure will begin playing when the closure is received at the [DAX—Affiliate] terminal.

2. Pseudo contact closure. This is an internal software signal which permits one play list to start another play list executing. This is used primarily to enable live audio to cut to other audio events stored in a play list.

3. Previous event termination (PET). PET event triggers cause an audio event to immediately follow its previous event. This results the flow of one event into another without pause or external input.

Having multiple events in a play list which have different event triggers can result in a rich operational feature set. For example, suppose a sequence of 3 commercials are to be played back to back following a contact closure. This play list would be set up so that audio event 1 (the first commercial) is closure triggered while the net two events are PET triggered. Further, the first two events would produce no termination signal while the third could be selected to produce a contact closure termination. The result is that a closure starts the commercials playing, each commercial plays in sequence and a contact closure is activated to indicate completion of the commercial set.

Termination Signal

When an audio event is done executing it may, optionally, generate a completion signal. There are two types of completion signal listed below. Either or both termination signal may be specified for any given audio event:

1. Contact closure. This causes a specified contact to close when the audio event is completed.

2. Pseudo contact closure. This is a software indication which can be used to resume a stopped play list.

User Recorded Events

Although not slated to be initially provided in the MEx feature list, there is no reason why subscriber stations cannot record their own audio events. Given this capability, it would be possible to convert what would otherwise be external events into internal events. The net result would be more station automation. It would be possible, then to have a show play from start to finish without interacting with the external station.

Play Lists

All of the required MEx functionality can be captured with lists of appropriately configured audio events. Such lists are called MEx Play lists. The following sections discuss the various requirements of the MEx system from the vantage point of play list management. Note that play lists can exist in several different states within the DAX terminal. These states are:

1. Dormant. Dormant lists are lists which have been created, but they are not currently assigned to any audio output. The lists can be auditioned, but they cannot be played.

2. Active. Active play lists are lists which are assigned to a given audio output. There may be several active play lists then the current audio event for each of the active play lists must have a different trigger.

3. Playing. Only one of the active play lists associated with a given output audio port may be playing at once.

Recorded Shows with Regional Spots

Recorded shows with regional spots are actually collections of audio files and a single active play list. Initially MEx will only support external audio events for local available spots. In other words the local commercials will be on cart machines in the stations. MEx will deliver recorded shows using the following sequence:

1. The head end system will deliver regional commercials to the designated stations using MEx addressable delivery. Commercials will be named for the position in the associated show. For example, “TOP 40 Spot 12”.

2. The head end system will deliver the show events. Each component will have a unique name such as “TOP 40 Segment 5”.

3. The head end system will deliver the play list. The play list will sequence the segments and the commercials along with the local available spots.

The following could be an example of a play list:

| | |
|---|---|
| Event 1 | TOP 40 Segment 1 |
| Event 2 | TOP 40 Spot 1 |
| Event 3 | TOP 40 Spot 2 |
| Event 4 | Local spot |
| Event 5 | TOP 40 Segment 2 |
| Event 6 | TOP 40 Spot 3 |
| Event 7 | Local spot |
| Event 8 | TOP 40 Segment 3 |

The system is set up to have Event 1 trigger on a contact closure. This starts the show playing. Event 2 and Event 3 are triggered on the termination of the previous event. This results in smooth flow from Event 1 to Event 2 to Event 3. Event 3 has as its termination signal a contact closure. This signifies the start of the local spot and can be used to interface to the station automation system that Event 4 is to start. Event 5 triggers on a contact closure which indicates the end of the local available spot indicated by Event 4. The play list along with the particular files down loaded into the DAX terminal are all that is required to produce the formatics sheet for the station. The formatics which the subscriber station manager can examine or print out is developed from the play list and the component audio files. Not that each audio event has a duration and an out cue associated with it. This permits the internal generation of the formatics for each show even it the regionalization results in different formatics (because of different outcues from regionalized commercials) at each station.

1. An improved method of transmitting at least audio information from production systems to one or more among a predetermined group of tail end users distal from the production systems, the improved method comprising the steps of
a. receiving at least a first audio signal on a first production system and at least a second audio signal on a second production system;
b. digitally encoding the first and second audio signals with a lossy compression algorithm to yield respective first and second lossy encoded files of lossy audio information;
c. predetermining a first group of tail end user apparatus for use of the first lossy encoded file and a second group of tail end user apparatus for use of the second lossy encoded file;
d. transmitting the lossy encoded files from the first and second production systems to a hub for automatic selective forwarding of the first and second lossy encoded files by the hub to the first and second groups of tail end user apparatus respectively; and
e. receiving, decoding, and playback broadcasting of the first and second lossy encoded files respectively on the first and second groups of tail end user apparatus, said decoding using a decoding algorithm for decoding of the lossy encoded file encoded with the lossy encoding algorithm.

2. The improved method of claim 1 wherein: (1) the transmission step (d) takes place without further lossy compression of the lossy audio information in the lossy encoded file; (2) the transmission step (d) includes transmission of a live encoded audio data stream by automatic multiplexing and transmitting the audio data stream with the lossy encoded file; and (3) the receiving step (e) includes automatically demultiplexing of the received multiplexed audio data stream and lossy encoded file, and live decoding and use of the audio data stream by the tail end user apparatus.

3. The improved method of claim 1 also including in step (e): playing the decoded file and automatically cross-fading the playback of the decoded file with the playback of a second audio file on the tail end user apparatus.

4. The improved method of claim 2 also including in step (e): playing the decoded file and automatically cross-fading the playback of the decoded file with the playback of a second audio file on the tail end user apparatus.

5. The improved method of claim 1 wherein transmitting step (d) includes transmitting a command in connection with the lossy encoded file, and receiving step (e) includes automatic activation and use of the lossy encoded file according to the command.

6. The improved method of claim 2 wherein transmitting step (d) includes transmitting a command in connection with the lossy encoded file, and receiving step (e) includes automatic activation and use of the lossy encoded file according to the command.

7. The improved method of claim 3 wherein transmitting step (d) includes transmitting a command in connection with the lossy encoded file, and receiving step (e) includes automatic activation and use of the lossy encoded file according to the command.

8. The improved method of claim 4 wherein transmitting step (d) includes transmitting contract closure information in connection with the lossy encoded file, and receiving step (e) includes automatic activation of demand for use of the lossy encoded file according to the instructions embodied in the contact closure information.

9. The improved method of claim 1 wherein the transmitting step (d) includes pre-determination of whether to transmit through an extraterrestrial satlellite or other link and then transmitting through the determined link.

10. The improved method of claim 2 wherein the transmitting step (d) includes pre-determination of whether to transmit through an extraterrestrial satlellite or other link and then transmitting through the determined link.

11. The improved method of claim 3 wherein the transmitting step (d) includes pre-determination of whether to transmit through an extraterrestrial satlellite or other link and then transmitting through the determined link.

12. The improved method of claim 4 wherein the transmitting step (d) includes pre-determination of whether to transmit through an extraterrestrial satlellite or other link and then transmitting through the determined link.

13. The improved method of claim 5 wherein the transmitting step (d) includes pre-determination of whether to transmit through an extraterrestrial satlellite or other link and then transmitting through the determined link.

14. The improved method of claim 6 wherein the transmitting step (d) includes pre determination of whether to transmit through an extraterrestrial satlellite or other link and then transmitting through the determined link.

15. The improved method of claim 7 wherein the transmitting step (d) includes pre determination of whether to transmit through an extraterrestrial satlellite or other link and then transmitting through the determined link.

16. The improved method of claim 8 wherein the transmitting step (d) includes pre-determination of whether to transmit through an extraterrestrial satlellite or other link and then transmitting through the determined link.

17. The improved method of claim 1 wherein the transmitting step (d) includes predetermined transmission through an extraterrestrial satellite.

18. The improved method of claim 2 wherein the transmitting step (d) includes predetermined transmission through an extraterrestrial satellite.

19. The improved method of claim 5 wherein the transmitting step (d) includes predetermined transmission through an extraterrestrial satellite.

20. The improved method of claim 8 wherein the transmitting step (d) includes predetermined transmission through an extraterrestrial satellite.
